(19) United States
(12) Patent Application Publication
(10) Pub. No.: US 2026/0014654 A1
(43) Pub. Date: Jan. 15, 2026

(54) WORKPIECE CONNECTING APPARATUS

(71) Applicants: STARTECHNO COMPANY LIMITED, Komaki-shi (JP); Nissan Motor Co., Ltd., Yokohama-shi (JP)

(72) Inventors: Tatsumi Hishikawa, Komaki-shi (JP); Kazuyuki Kurimoto, Komaki-shi (JP); Akihiro Kousai, Atsugi-shi (JP); Shuitirou Maruta, Atsugi-shi (JP); Tomonori Tazuke, Atsugi-shi (JP)

(73) Assignees: STARTECHNO COMPANY LIMITED, Komaki-shi (JP); Nissan Motor Co., Ltd., Yokohama-shi (JP)

(21) Appl. No.: 19/334,115

(22) Filed: Sep. 19, 2025

Related U.S. Application Data
(63) Continuation of application No. PCT/JP2023/017396, filed on May 9, 2023.

(51) Int. Cl. B23K 37/04; B23K 20/10; B23K 37/02

(52) U.S. Cl. CPC B23K 37/0408; B23K 20/10; B23K 37/0211

(57) ABSTRACT

A workpiece connecting apparatus, which is capable of quickly connecting a component to a workpiece even if the workpiece has a complicated shape, connects a second workpiece to a front surface of a first workpiece by urging the second workpiece against the front surface of the first workpiece. The workpiece connecting apparatus includes, in particular, a first pressing articulated robot and a supporting body connected to a distal end of the first pressing articulated robot and capable of being abutted on the back surface of the first workpiece.

### TECHNICAL FIELD

The present invention relates to a workpiece connecting apparatus for connecting a plurality of workpieces.

### BACKGROUND

Conventionally, a workpiece connecting apparatus for connecting a plurality of workpieces has been known, and for example, it is recognized that Patent Document 1 describes a laser processing apparatus 1 that laser welds a component P to a workpiece W placed on a work table 4 (see paragraphs to and FIG. 10 etc.).

The laser processing apparatus 1 described in Patent Document 1 is configured to press an upper surface of a workpiece W and an upper surface of a component P placed on a work table 4 by a pressing portion 26, and in this state, irradiate the workpiece W and the component P with a laser beam L from a laser processing head 5 to connect the workpiece W and the component P (see paragraphs to [0057], FIG. 10 etc.).

### PRIOR ART DOCUMENTS

### Patent Documents

Patent Document 1: Japanese Patent Application Publication No. 2022-054106 A

### SUMMARY

### Technical Problems

However, in the laser processing apparatus 1 described in Patent Document 1 (hereinafter referred to as “workpiece connection apparatus”), as described in Patent Document 1, when the workpiece W has a planar shape and the work table 4 has a planar shape, there is no problem in the connection, but when the workpiece W has a complicated shape such as a curved shape or a bent shape, there is a problem that it is very difficult to connect the component P to any place of the workpiece W having a complicated shape.

On the other hand, it is also conceivable to change the shape of the work table 4 in accordance with the shape of the workpiece W, but in that case, the work table 4 needs to be changed every time the shape of the workpiece W is changed, therefore, there is also a problem that the work efficiency is deteriorated.

In addition, as a matter of course, it is desirable that the workpiece W to which the component P is connected by laser welding has a good appearance.

The present invention has been made in view of the above-described problems of the conventional technique, and an object of the present invention is to provide a workpiece connecting apparatus capable of quickly connecting a component to a workpiece even when the workpiece has a complicated shape, and a workpiece connecting apparatus capable of improving the appearance quality of the workpiece after connection.

### Solution for Problems

In order to solve the above-described problem, a first aspect of the present invention is a workpiece connecting apparatus that urges a second workpiece against a front surface of a first workpiece to connect the second workpiece to the front surface of the first workpiece, the workpiece connecting apparatus includes an articulated robot, and a supporting body connected to a distal end of the articulated robot and capable of abutting on a back surface of the first workpiece.

### Advantageous Effects of Invention

According to a first aspect of the present invention, a workpiece connecting apparatus that urges a second workpiece against a front surface of a first workpiece to connect the second workpiece to the front surface of the first workpiece includes an articulated robot, and a supporting body connected to a distal end of the articulated robot and capable of abutting on a back surface of the first workpiece. Therefore, even if the first workpiece has a complicated shape, an appropriate supporting body is capable of being abutted on the back surface of the first workpiece, and ultimately the second workpiece is capable of being quickly connected to the front surface of the first workpiece.

In addition, according to the second aspect of the present invention, in the workpiece connecting apparatus according to the first aspect, the supporting body includes a plurality of first plates arranged so that normal lines of the first plates are oriented in a plurality of directions. Therefore, in addition to the effect of the workpiece connecting apparatus of the first aspect, even if the first workpiece has a complicated shape, an appropriate first plate capable of being selected and abutted on the back surface of the first workpiece, and ultimately the second workpiece is capable of being efficiently connected to the front surface of the first workpiece. On the other hand, even if one first plate becomes unusable, another first plate is capable of being used, so that the durability of the workpiece connecting apparatus is capable of being improved.

In addition, according to the third aspect of the present invention, in the workpiece connecting apparatus according to the second aspect, a polyhedron is connected to the distal end of the articulated robot, each of the plurality of first plates is separately connected to one of the faces constituting the polyhedron. Therefore, in addition to the effect of the workpiece connecting apparatus of the second aspect, it is possible to easily create a structure in which an appropriate first plate is capable of being selected and abutted on the first workpiece of a complicated shape.

In addition, according to a fourth aspect of the present invention, in the workpiece connecting apparatus according to the third aspect, the polyhedron includes an opening surface and a cavity therein, each of the plurality of first plates is clamped to the polyhedron by a fastener from the cavity and is separately connected to one of the faces constituting the polyhedron. Therefore, in addition to the effect of the workpiece connecting apparatus of the third aspect, it is possible to easily create a structure in which an appropriate first plate is capable of being selected and firmly abutted on the first workpiece of a complicated shape.

In addition, according to the fifth aspect of the present invention, in the workpiece connecting apparatus of any one of the second to fourth aspects, the first plate has a structure in which a central portion protrudes. Therefore, in addition to the effects of the workpiece connecting apparatus of any one of the second to fourth aspects, it is possible to prevent distortion occurring on the front surface of the first workpiece and/or the front surface of the second workpiece, thereby improving the appearance quality.

In addition, according to a sixth aspect of the present invention, in the workpiece connecting apparatus that urges a second workpiece against a front surface of a first workpiece to connect the second workpiece to the front surface of the first workpiece, the workpiece connecting apparatus including a moving body, and at least one second plate is disposed on the moving body, capable of abutting on a back surface of the first workpiece, and so that a normal line of the at least one second plate is capable of changing in a plurality of directions, wherein the at least one second plate is capable of fixing a normal direction when the at least one second plate abuts against the back surface of the first workpiece. Therefore, even if the first workpiece has a complicated shape, an at least one second plate is capable of being abutted on the back surface of the first workpiece, and ultimately the second workpiece is capable of being quickly connected to the front surface of the first workpiece.

Furthermore, according to a seventh aspect of the present invention, in the workpiece connecting apparatus according to the sixth aspect, the at least one second plate has a structure in which a central portion protrudes. Therefore, in addition to the effects of the workpiece connecting apparatus of the sixth aspects, it is possible to prevent distortion occurring on the front surface of the first workpiece and/or the front surface of the second workpiece, thereby improving the appearance quality.

### BRIEF DESCRIPTION OF DRAWINGS

FIG. 1 is an overall front view of a workpiece connecting apparatus according to a first embodiment of the present invention.

FIG. 2 is a front view of a first workpiece according to the first embodiment.

FIG. 3 is a plan view showing a first workpiece and a second workpiece of the first embodiment.

FIG. 4 is a left side view of a first pressing portion of the first embodiment.

FIG. 5 is a bottom view of a first pressing portion of the first embodiment.

FIG. 6 is a cross-sectional view taken along line A-A in FIG. 4.

FIG. 7 is a plan view of a second pressing portion and a third pressing portion of the first embodiment.

FIG. 8 is a side view showing a state before a second pressing portion of the first embodiment is extended.

FIG. 9 is a side view showing a state after the second pressing portion of the first embodiment is extended.

FIG. 10 is a block diagram of the workpiece connecting apparatus according to the first embodiment.

FIG. 11 is a block diagram of a main controller of the workpiece connecting apparatus according to the first embodiment.

FIG. 12 is a flowchart of a connection processing program in the workpiece connecting apparatus of the first embodiment.

FIG. 13 is a flowchart of a first pressing portion selection program in the workpiece connecting apparatus of the first embodiment.

FIG. 14 is a flowchart of an operation program of a second pressing portion and the like in the workpiece connecting apparatus of the first embodiment.

FIG. 15 is a view showing a state of a first stage of a first pressing portion in the workpiece connecting apparatus of the first embodiment.

FIG. 16 is a view showing a state of a second stage of the first pressing portion in the workpiece connecting apparatus of the first embodiment.

FIG. 17 is a view showing a state of a final stage of the first pressing portion in the workpiece connecting apparatus of the first embodiment.

FIG. 18 is an enlarged view of area B in FIG. 17.

FIG. 19 is a view showing a state in which the first pressing portion in the workpiece connecting apparatus of the first embodiment presses the other portion of the first workpiece.

FIG. 20 is a view showing a state of a first stage of a second pressing portion in the workpiece connecting apparatus of the first embodiment.

FIG. 21 is a view showing a state of a second stage of the second pressing portion in the workpiece connecting apparatus of the first embodiment.

FIG. 22 is a view showing a state of a final stage of the second pressing portion in the workpiece connecting apparatus of the first embodiment.

FIG. 23 is a side view showing a state in which the second pressing portion of the first embodiment abuts against the horizontal surface of the first workpiece.

FIG. 24 is a side view showing a state in which the second pressing portion of the first embodiment abuts against the inclined surface of the first workpiece.

FIG. 25 is a left side view of a first pressing portion of the second embodiment.

FIG. 26 is a cross-sectional view taken along line C-C of FIG. 25.

FIG. 27 is a left side view of a first pressing portion of the third embodiment.

FIG. 28 is a left side view of the first pressing portion of the fourth embodiment.

FIG. 29 is a left side view of a first pressing portion of the fifth embodiment.

FIG. 30 is a side view showing a second pressing portion of the sixth embodiment.

### DETAILED DESCRIPTION

Hereinafter, embodiments of the present invention will be described with reference to the drawings.

### First Embodiment

First of all, a first embodiment of the present invention will be described. The drawings used in the present embodiment are exaggerated for easy understanding, and the dimensions thereof are different from the actual dimensions.

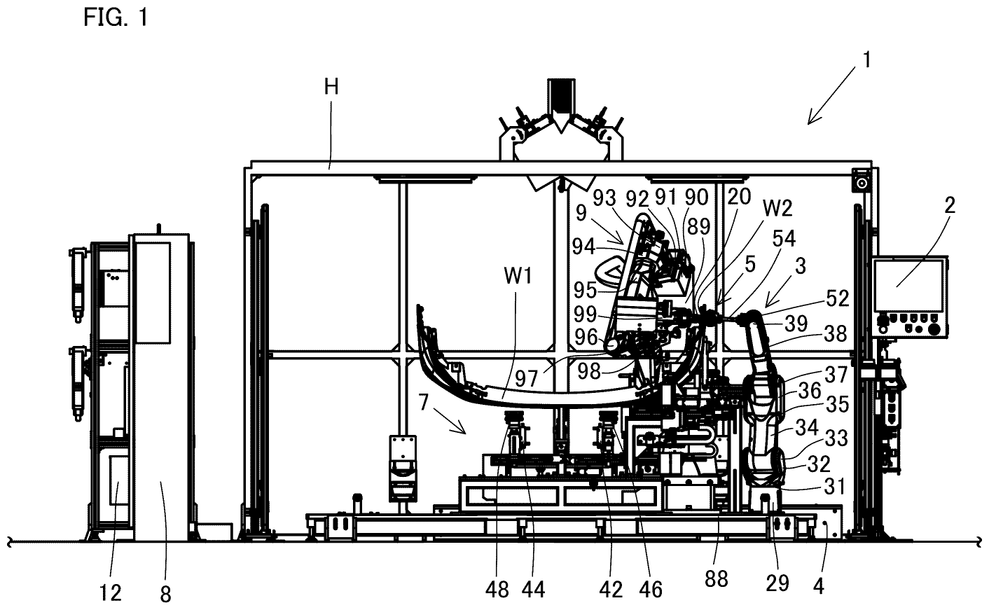

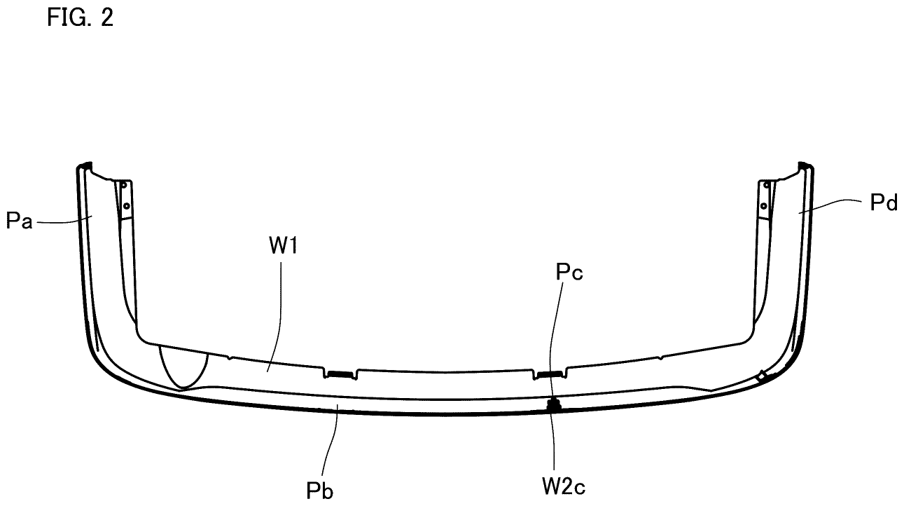

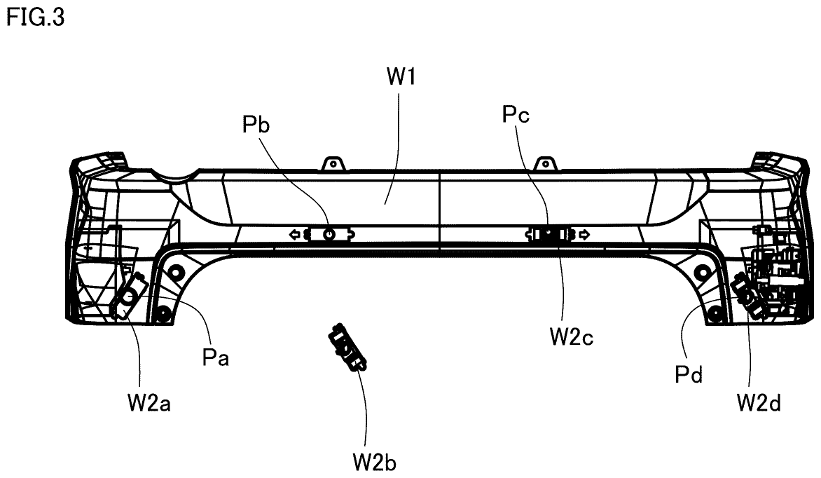

FIG. 1 is an overall front view of a workpiece connecting apparatus according to a first embodiment of the present invention, FIG. 2 is a front view of a first workpiece according to the first embodiment, and FIG. 3 is a plan view showing a first workpiece and a second workpiece of the first embodiment.

As shown in FIG. 1, a workpiece connecting apparatus 1 of the present embodiment uses a welding articulated robot 9, a first pressing articulated robot 3, and a second and third pressing mechanism 7 to urge a second workpiece W2 against a first workpiece W1 fixed on a mounting table 88 disposed in a housing H and to connect the second workpiece W2 to the first workpiece W1.

In the present embodiment, for convenience of description, one first pressing articulated robot 3 is disposed on the right side of the first workpiece W1 in FIG. 1, but actually, two first pressing articulated robots 3 are disposed on both left and right sides of the first workpiece W1.

The arrangement position and the number of the first pressing articulated robots 3 may be changed as appropriate according to the shape of the first workpiece W1.

In addition, as shown in FIG. 2 and FIG. 3, in the present embodiment, the first workpiece W1 is described to take a bumper of a vehicle as an example, and the second workpiece W2a, W2b, W2c and W2d are respectively connected to four connection positions Pa,Pb,Pc and Pd of the first workpiece W1, but the shapes of the first workpiece W1 and the second workpiece W2, and the number of connections and the connection positions of the second workpiece W2 are not limited thereto, and may be changed as appropriate.

As shown in FIG. 1, the workpiece connecting apparatus 1 of the present embodiment includes the mounting table 88 disposed in the housing H, the welding articulated robot 9, the first pressing articulated robot 3, and the second and third pressing mechanism 7 fixed to the mounting table 88, a control device 8 for controlling the entire workpiece connecting apparatus 1, a robot controller 12 for controlling the welding articulated robot 9 and the first pressing articulated robot 3, an air compressor 4 for controlling a part of the operation of the second and third pressing mechanism 7, and an operation panel 2 disposed on the housing H and used by an operator of the workpiece connecting apparatus for commanding the operation of the workpiece connecting apparatus 1.

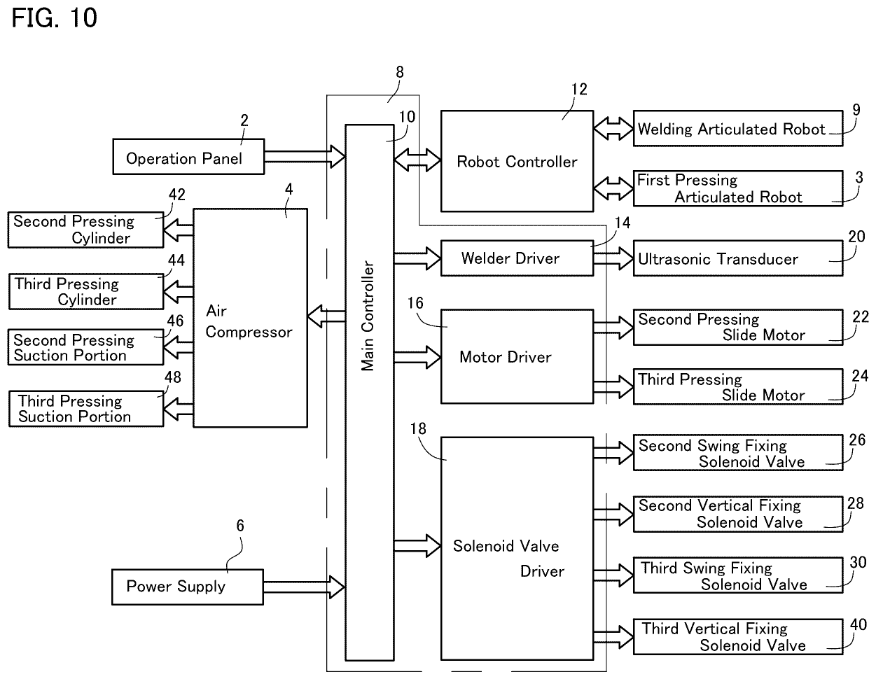

The welding articulated robot 9 is a general 6-axis multi-joint robot that operates in accordance with commands from the robot controller 12, and urges a second workpiece W2 against a first workpiece W1 and welds the second workpiece W2 to the first workpiece W1 by an ultrasonic transducer 20 (see FIG. 10) connected to the distal end of the welding articulated robot 9.

The welding articulated robot 9 includes six shafts, that is, a first rotation shaft (not shown) for rotating a first base 89 with respect to the mounting table 88, a second rotation shaft 90 for rotating a lower arm portion 91 back and forth with respect to the first base 89, a third rotation shaft 92 for rotating a first middle arm portion 93 with respect to the lower arm portion 91, a fourth rotation shaft 94 for rotating a second middle arm portion 95 with respect to the first middle arm portion 93, a fifth rotation shaft 96 for rotating an upper arm portion 97 with respect to the second middle arm portion 95, and a sixth rotation shaft 98 for coaxially rotating a rotating portion 99 with respect to the upper arm portion 97.

An ultrasonic transducer 20 is fixed to a distal end of the rotating portion 99 of the welding articulated robot 9, and in a state where the second workpiece W2 is placed on the first workpiece W1, the ultrasonic transducer 20 is butted against the first workpiece W1 and the second workpiece W2, and the ultrasonic transducer 20 is driven by signals from a welder driver 14 (see FIG. 10) described below, thereby welding the second workpiece W2 to the first workpiece W1.

The first pressing articulated robot 3 is a general five axis multi-joint robot that operates according to commands from the robot controller 12, presses the back surface of the first workpiece W1 by a first pressing portion 5 connected to a distal end of the first pressing articulated robot 3 when the welding articulated robot 9 welds the second workpiece W2 to the first workpiece W1.

The first pressing articulated robot 3 includes five shafts, that is, a first rotation shaft 31 for rotating a second base 32 with respect to a first base 29, a second rotation shaft 33 for rotating a lower arm portion 34 back and forth with respect to the second base 32, a third rotation shaft 35 for rotating a middle arm portion 36 back and forth with respect to the lower arm portion 34, a fourth rotation shaft 37 for rotating an upper arm portion 38 back and forth with respect to the middle arm portion 36, and a fifth rotation shaft 39 for rotating the first pressing portion 5 with respect to the upper arm portion 38.

Next, the first pressing portion 5 of the present embodiment will be described.

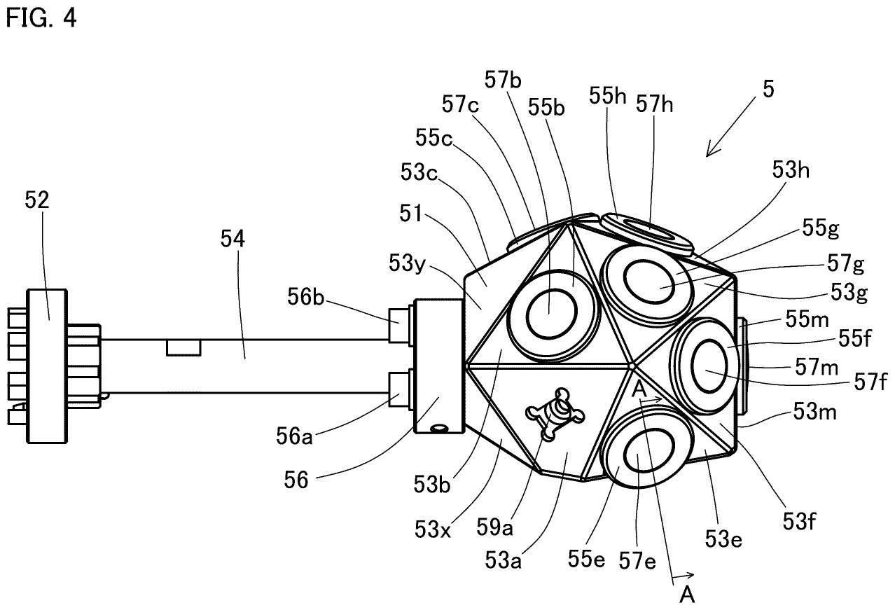

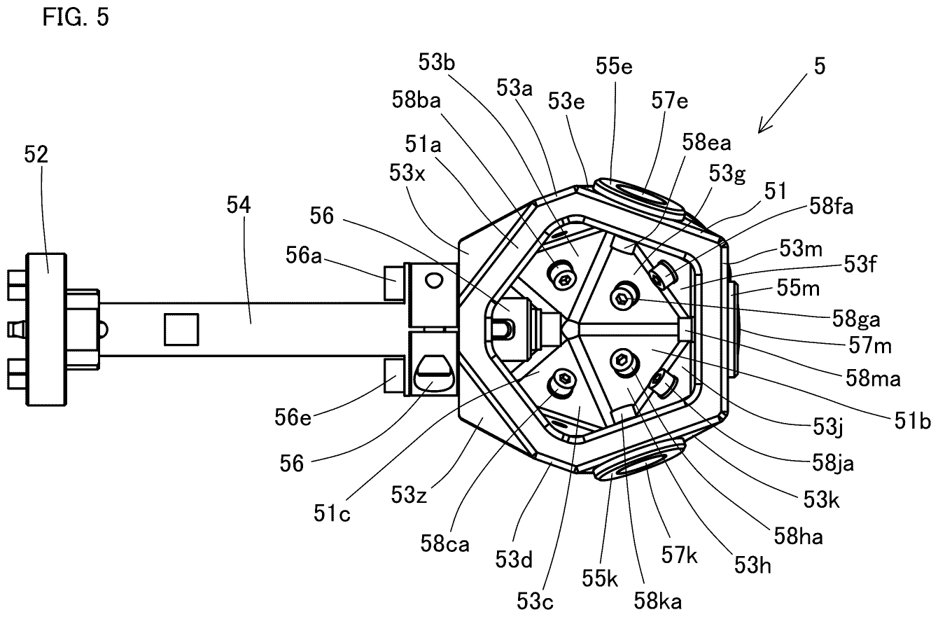

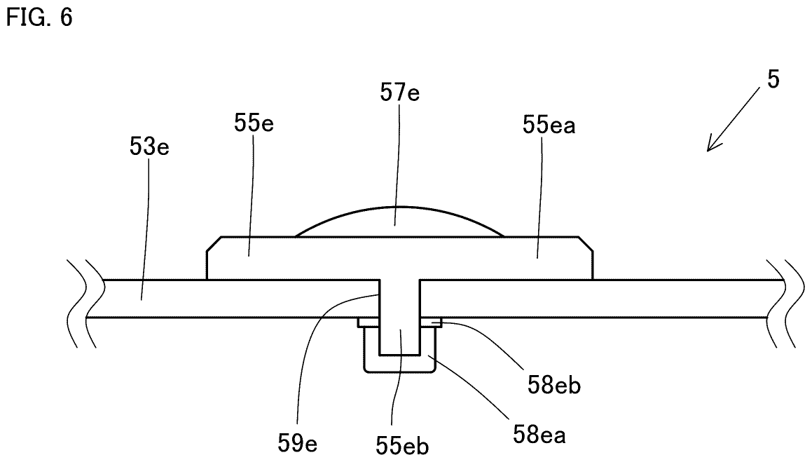

FIG. 4 is a left side view of the first pressing portion of the present embodiment, FIG. 5 is a bottom view thereof, and FIG. 6 is a cross-sectional view taken along line A-A in FIG. 4.

As described above, the first pressing portion 5 of the present embodiment presses the back surface of the first workpiece W1 when the welding articulated robot 9 welds the second workpiece W2 to the first workpiece W1.

As shown in FIGS. 4 and 5, the first pressing portion 5 of the present embodiment includes a first attachment portion 52 connected to the fifth rotation shaft 39 of the first pressing articulated robot 3, a long arm portion 54 having one end connected to the first attachment portion 52, a second attachment portion 56 connected to the other of the arm portion 54 by five attachment tools 56a, 56b, 56c, 56d and 56e, and a supporting body 51 connected to the second attachment portion 56.

The supporting body 51 is formed of a polyhedron including fourteen substantially triangular flat first plates 53a, 53b, 53c, 53d, 53e, 53f, 53g, 53h, 53j, 53k, 53m, 53x, 53y and 53z. Predetermined thickness flat disks 55a (not shown), 55b, 55c, 55d (not shown), 55e, 55f, 55g, 55h, 55j (not shown), 55k and 55m having plan view circular protruding portions 57a (not shown), 57b, 57c, 57d (not shown), 57e, 57f, 57g, 57h, 57j (not shown), 57k and 57m of which a central portion protrudes in the substantially triangular outer periphery of the first plate are fixed on the front surfaces of the respective first plates excluding the first plates 53x, 53y, and 53z in the polyhedron.

In FIG. 4 and FIGS. 18 and 19 described below, in order to facilitate the understanding of the assembly of the first pressing portion 5, the first plates 53a and 53d are illustrated in a state before the disks 55a and 55d are attached, but actually, the disks 55a and 55d are also attached to the first plate 53a and 53d, similarly to the other first plates.

In addition, the normal lines of the first plates 53a, 53b, 53c, 53d, 53e, 53f, 53g, 53h, 53j, 53k, 53m, 53x, 53y and 53z are arranged so as to be oriented in different directions.

As shown in FIGS. 5 and 6, the supporting body 51 includes an opening surface 51b formed by a housing 51a and a cavity 51c formed inside a polyhedron. Each of disks 55a (not shown), 55b, 55c, 55d (not shown), 55e, 55f, 55g, 55h, 55j (not shown), 55k and 55m includes a disk body 55aa, 55ba, 55ca, 55da, 55ea, 55fa, 55ga, 55ha, 55ja, 55ka or 55ma (not shown except disk body 55ea) and a screw portion 55ab, 55bb, 55cb, 55db, 55eb, 55fb, 55gb, 55hb, 55jb, 55kb or 55mb (not shown except screw portion 55eb) extending from the disk body.

Then, each of the disks 55a (not shown), 55b, 55c, 55d (not shown), 55e, 55f, 55g, 55h, 55j (not shown), 55k and 55m is individually clamped by fasteners 58aa (not shown), 58ba, 58ca, 58da (not shown), 58ea, 58fa, 58ga, 58ha, 58ja, 58ka or 58ma from the cavity 51c and washers 58ab, 58bb, 58cb, 58db, 58eb, 58fb, 58gb, 58hb, 58jb, 58kb or 58mb (not shown except washer 58eb) via holes 59a, 59b, 59c, 59d, 59e, 59f, 59g, 59h, 59j, 59k or 59m (not shown except holes 59a, 59d and 59e) of the first plates 53a, 53b, 53c, 53d, 53e, 53f, 53g, 53h, 53j, 53k or 53m.

Next, the second and third pressing mechanism 7 of the present embodiment will be described.

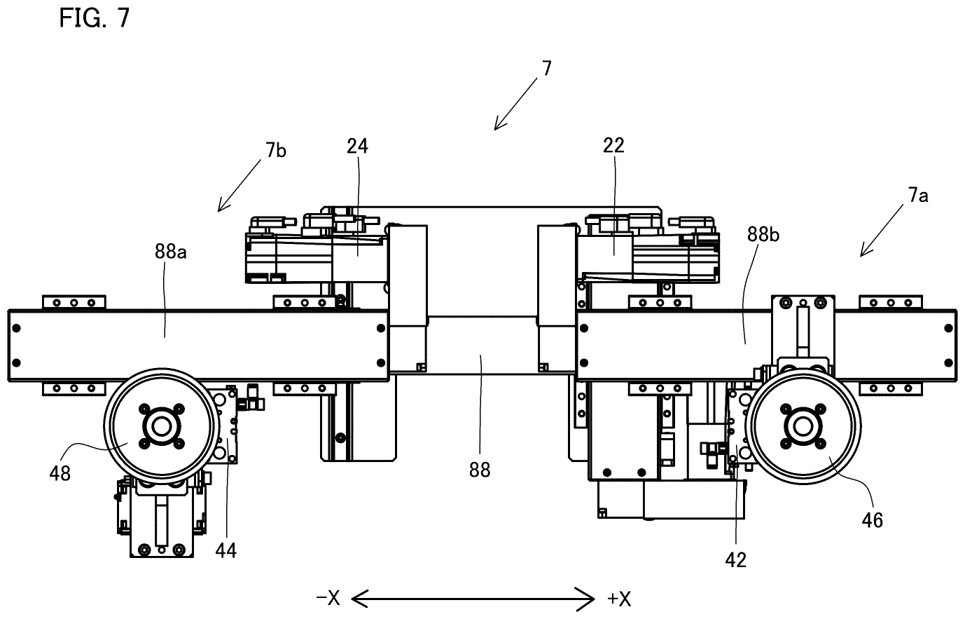

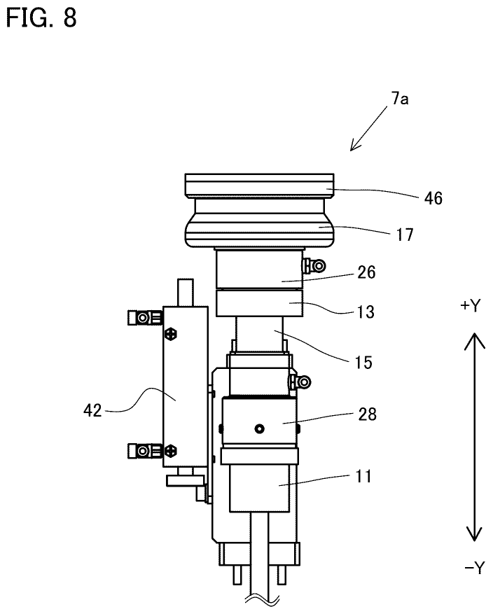

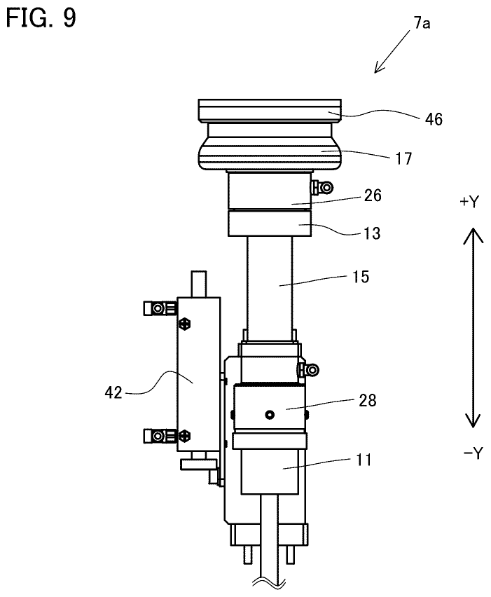

FIG. 7 is a plan view of a second pressing portion and a third pressing portion of the first embodiment, FIG. 8 is a side view showing a state before a second pressing portion of the first embodiment is extended, and FIG. 9 is a side view showing a state after the second pressing portion of the first embodiment is extended.

Similarly to the first pressing portion 5, the second and third pressing mechanism 7 presses the back surface of the first workpiece W1 when the welding articulated robot 9 welds the second workpiece W2 to the first workpiece W1, in the present embodiment, as shown in FIG. 1, two pressing portions of a second pressing portion 7a and a third pressing portion 7b are provided at the lower part of the first workpiece W1.

The arrangement positions and the number of the second pressing portion 7a and the third pressing portion 7b described below, of the second and third pressing mechanism 7 may be changed as appropriate according to the shape of the first workpiece W1.

As shown in FIGS. 1 and 7, the second and third pressing mechanism 7 of the present embodiment includes a second pressing portion 7a on the upper right side of FIG. 1 and the third pressing portion 7b on the upper left side of FIG. 1 along the longitudinal direction of the first workpiece W1 in a lower portion of the first workpiece W1.

As shown in FIGS. 7 to 9, the second pressing portion 7a includes a first base portion 11, a telescopic rod 15 extensible with respect to the first base portion 11, a compression spring (not shown) that is disposed inside the telescopic rod 15 and urges the telescopic rod 15 upward, a second pressing cylinder 42 extending and contracting the telescopic rod 15 with respect to the first base portion 11, a second vertical fixing solenoid valve 28 that is disposed on an upper portion of the first base portion 11 and fixes a vertical position of the telescopic rod 15, a second base portion 13 that is fixed to an upper end of the telescopic rod 15, a second swing fixing solenoid valve 26 that is disposed on an upper portion of the second base portion 13 and fixes swing of a second pressing suction portion 46 described below, a telescopic portion 17 that is disposed on an upper portion of the second swing fixing solenoid valve 26 and is extensible, and a second pressing suction portion 46 (corresponding to a “second plate” of the invention) that is disposed on an upper portion of the telescopic portion 17.

In the second pressing portion 7a configured as described above, firstly, the second base portion 13, the second swing fixing solenoid valve 26, the telescopic portion 17, and the second pressing suction portion 46 descend in the −rection by the second pressing cylinder 42, and then the telescopic rod 15 is fixed at the lowered position in a state the compression spring is compressed by the second vertical fixing solenoid valve 28.

At this time, the second swing fixing solenoid valve 26 may fix the telescopic portion 17 and the second pressing suction portion 46, but in consideration of the subsequent steps, it is preferable that the telescopic portion 17 and the second pressing suction portion 46 are not fixed and the telescopic portion 17 and the second pressing suction portion 46 are in a swingable state.

FIG. 8 illustrates a state in which the second base portion 13, the second swing fixing solenoid valve 26, the telescopic portion 17, and the second pressing suction portion 46 descend.

Thereafter, when the second vertical fixing solenoid valve 28 is released after the second pressing cylinder 42 is released from the telescopic rod 15, the second base portion 13, the second swing fixing solenoid valve 26, the telescopic portion 17, and the second pressing suction portion 46 ascend in the +Y direction by a force of the compression spring.

FIG. 9 illustrates a state in which the second base portion 13, the second swing fixing solenoid valve 26, the telescopic portion 17, and the second pressing suction portion 46 ascend.

In addition, as shown in FIG. 7, the second pressing portion 7a is configured to transmit a rotational force of a motor gear fixed to a motor shaft of a second pressing slide motor 22 to the ball screw by using the second pressing slide motor 22 disposed in the vicinity of the right mounting table 88b and a ball screw disposed inside the right mounting table 88b, and to be movable in +X direction or −X direction on a right mounting table 88b fixed to the mounting table 88.

In addition, the third pressing portion 7b has the same structure as the second pressing portion 7a except for a third pressing cylinder 44 that extends and contracts the telescopic rod with respect to the first base portion, and a third pressing suction portion 48 (corresponding to a “second plate” of the present invention) disposed on an upper portion of the telescopic portion.

Similarly to the second pressing portion 7a, in the third pressing portion 7b, a second base portion (not shown), a third swing fixing solenoid valve 30, a telescopic portion (not shown), and the third pressing suction portion 48 descend in the −rection by the third pressing cylinder 44, and then the telescopic rod is fixed at the lowered position in a state the compression spring is compressed by a third vertical fixing solenoid valve 40.

At this time, the third swing fixing solenoid valve 30 may fix the telescopic portion and the third pressing suction portion 48, but in consideration of the subsequent steps, it is preferable that the telescopic portion and the third pressing suction portion 48 are not fixed and the telescopic portion and the third pressing suction portion 48 are in a swingable state.

Thereafter, when the third vertical fixing solenoid valve 40 is released after the third pressing cylinder 44 is released from the telescopic rod, the second base portion, the third swing fixing solenoid valve 30, the telescopic portion, and the third pressing suction portion 48 ascend in the +Y direction by the force of the compression spring.

In addition, as shown in FIG. 7, the third pressing portion 7b is configured to transmit a rotational force of a motor gear fixed to a motor shaft of a third pressing slide motor 24 to the ball screw by using the third pressing slide motor 24 disposed in the vicinity of the left mounting table 88a and a ball screw disposed inside the left mounting table 88a, and to be movable in the +X direction or the −X direction on the left monting table 88a fixed to the mounting table 88.

Next, a block diagram of the workpiece connecting apparatus 1 of the present embodiment will be described.

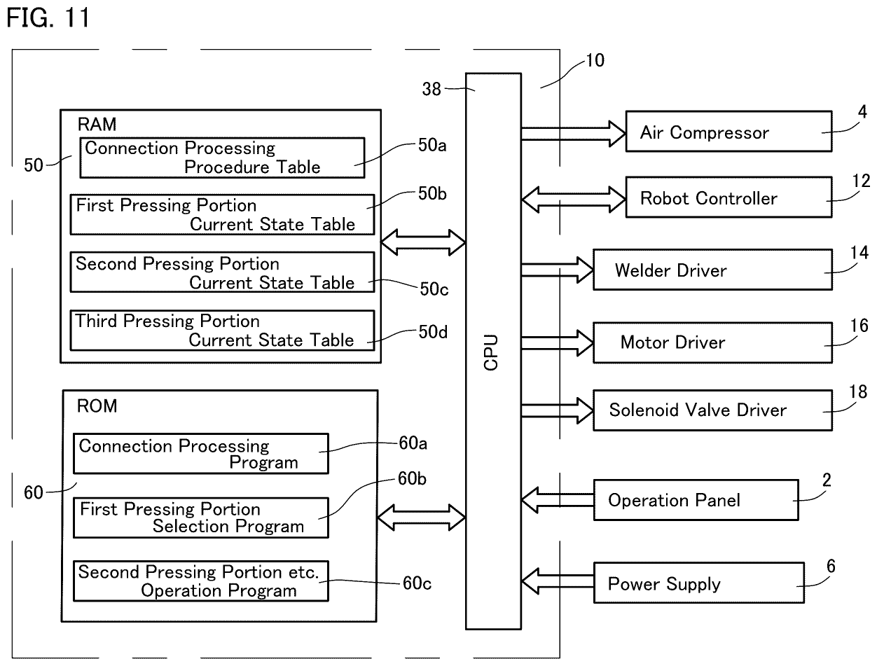

FIG. 10 is a block diagram of the workpiece connecting apparatus of the present embodiment, and FIG. 11 is a block diagram of a main controller of the workpiece connecting apparatus of the present embodiment.

In FIG. 10, the workpiece connecting apparatus 1 includes a main controller 10 electrically connected to a power supply 6, the air compressor 4 electrically connected to the main controller 10 and configured to drive the second pressing cylinder 42, the third pressing cylinder 44, the second pressing suction portion 46, and the third pressing suction portion 48, a robot controller 12 electrically connected to the main controller 10 and configured to control the welding articulated robot 9 and the first pressing articulated robot 3, a welder driver 14 configured to drive the ultrasonic transducer 20, a motor driver 16 configured to drive the second pressing slide motor 22 and the third pressing slide motor 24, a solenoid valve driver 18 configured to drive the second swing fixing solenoid valve 26, the second vertical fixing solenoid valve 28, the third swing fixing solenoid valve 30, and the third vertical fixing solenoid valve 40, and the operation panel 2 configured to receive an input from an operator of the workpiece connecting apparatus.

The main controller 10, the welder driver 14, the motor driver 16, and the solenoid valve driver 18 are contained in a control device 8.

In addition, in FIG. 11, the main controller 10 includes a CPU (Central Processing Unit) 38, a RAM (Random Access Memory) 50 connected to the CPU 38 so as to be able to input and output, and a ROM (Read Only Memory) 60 connected to the CPU 38 so as to be able to input and output.

The RAM 50 includes a connection processing procedure table 50a that stores a connection position for connecting the second workpiece W2 to the first workpiece W1, inclination information (inclination direction and inclination angle) at the connection position, and a connection order, a first pressing portion current state table 50b that stores a current state of the first pressing portion 5, a second pressing portion current state table 50c that stores a current state of the second pressing portion 7a, and a third pressing portion current state table 50d that stores a current state of the third pressing portion 7b.

In addition, the ROM 60 includes a connection processing program 60a that controls an operation of the entire workpiece connecting apparatus 1 of the present embodiment, a first pressing portion selection program 60b for selecting a surface to be used of the first pressing portion 5, and a second pressing portion etc. operation program 60c that controls an operation of the second pressing portion 7b and the third pressing portion 7b.

Next, an operation of the workpiece connecting apparatus 1 describled above will be described.

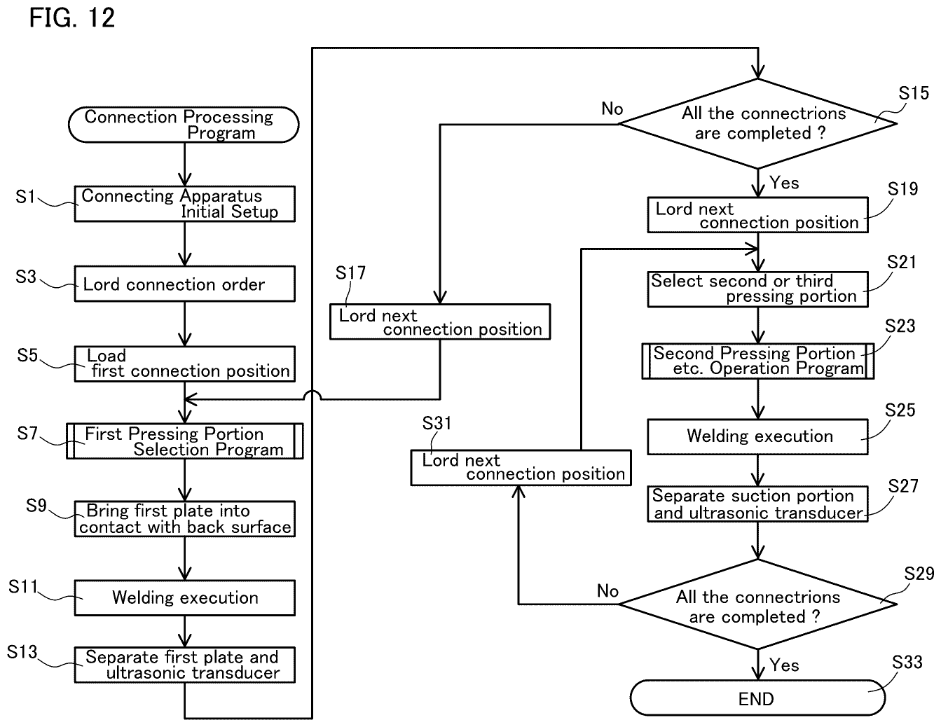

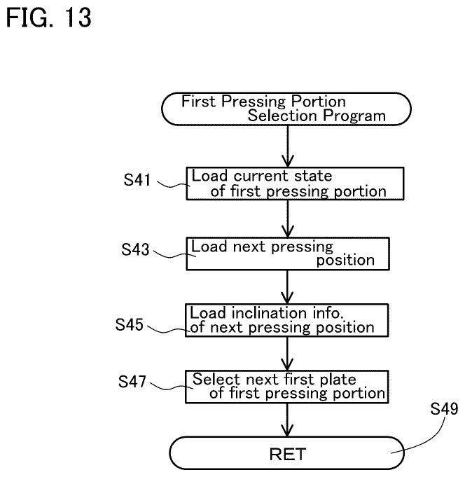

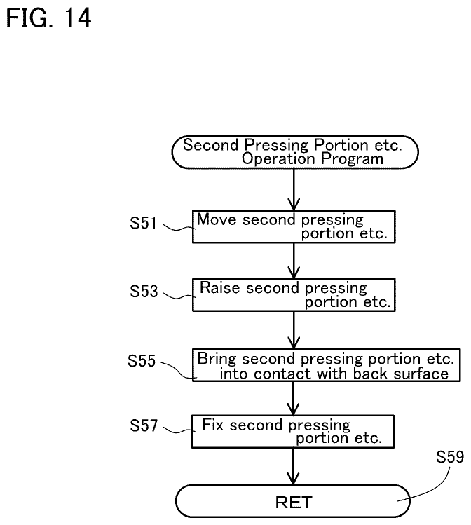

FIG. 12 is a flowchart of a connection processing program in the workpiece connection apparatus of the present embodiment, FIG. 13 is a flowchart of a first pressing portion selection program in the workpiece connection apparatus of the present embodiment, and FIG. 14 is a flowchart of a second pressing portion etc. operation program in the workpiece connection apparatus of the present embodiment.

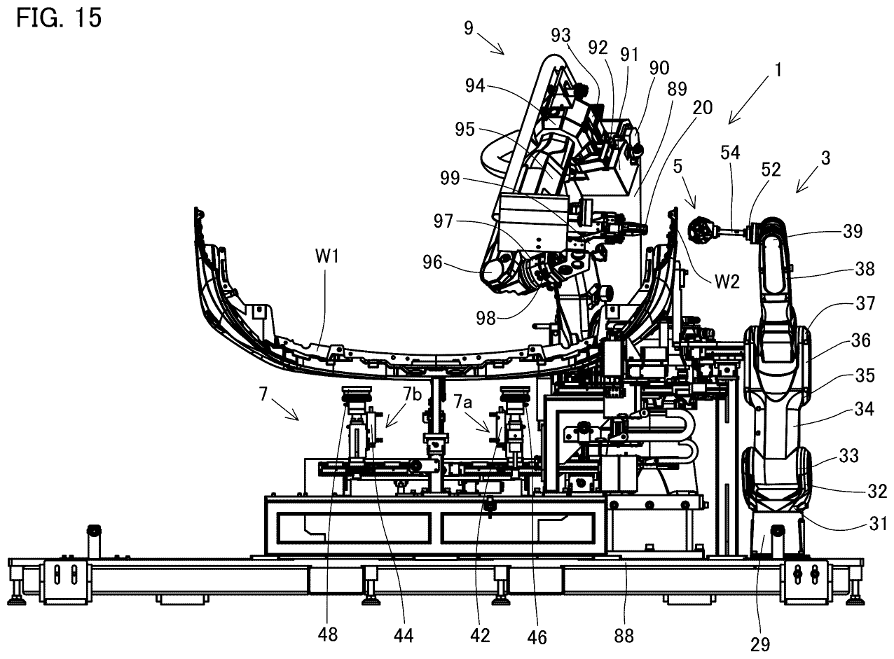

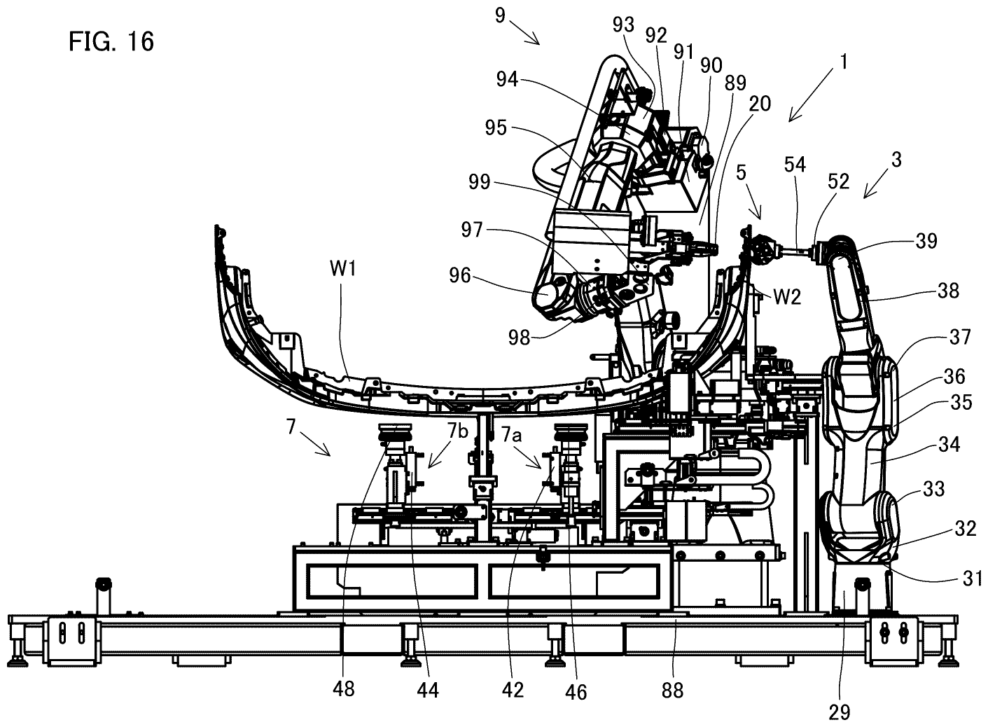

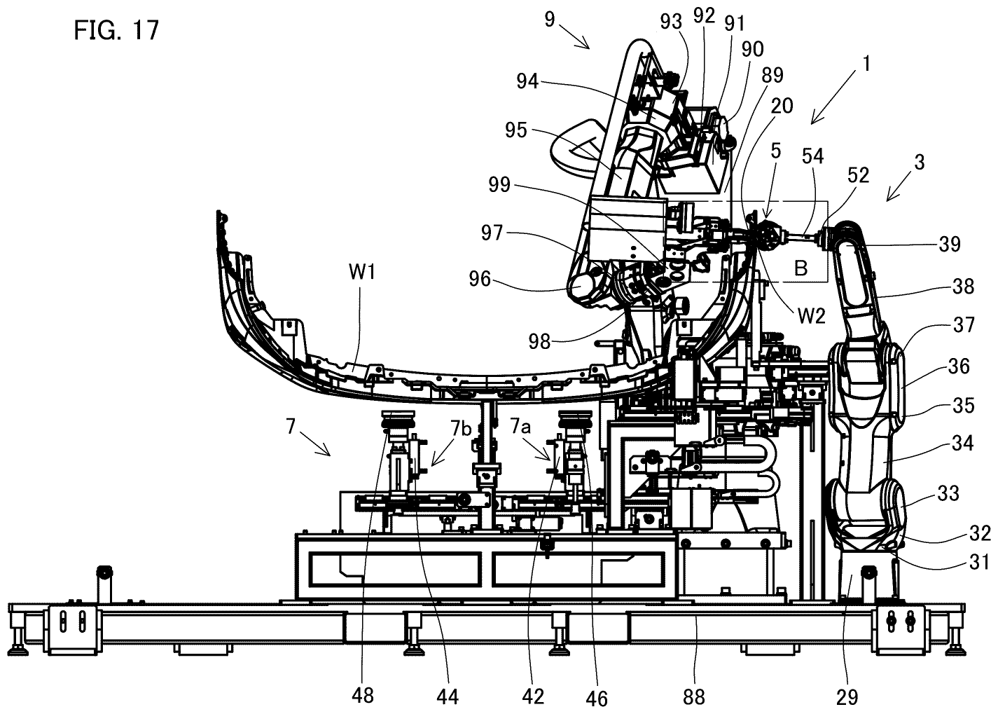

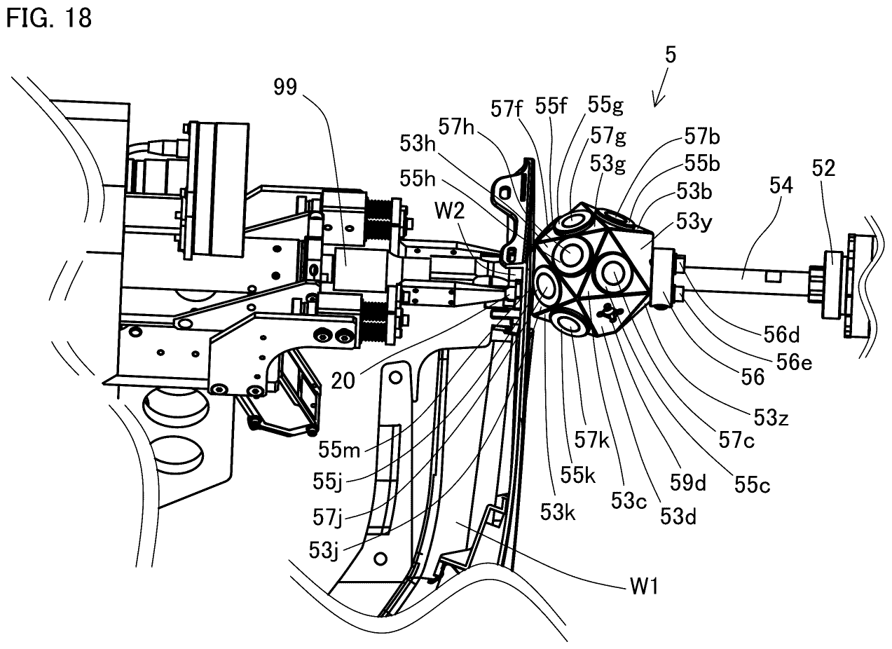

In addition, FIG. 15 is a view showing a state of a first stage of the first pressing portion in the workpiece connecting apparatus of the present embodiment, FIG. 16 is a view showing a state of a second stage of the first pressing portion, FIG. 17 is a view showing a state of a final stage of the first pressing portion, and FIG. 18 is an enlarged view of a portion B of FIG. 17.

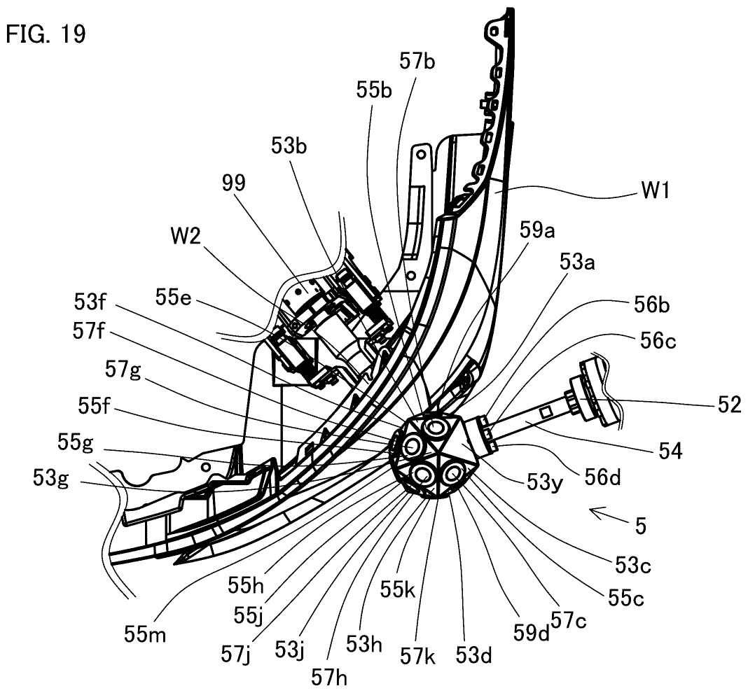

In addition, FIG. 19 is a diagram illustrating a state in which the first pressing unit presses the other portion of the first workpiece.

As described above, the workpiece connecting apparatus 1 of the present embodiment urge a second workpiece W2 against a first workpiece W1 fixed on a mounting table 88 disposed in a housing H and to connect the second workpiece W2 to the first workpiece W1 by using the welding articulated robot 9, the first pressing articulated robot 3, and the second and third pressing mechanism 7.

First of all, before operating the workpiece connecting apparatus 1, an operator of the workpiece connecting apparatus 1 sets the first workpiece W1 on the mounting table 88 and sets the second workpiece W2 at a connection portion of the first workpiece W1.

Thereafter, when the operator of the apparatus turns on the power supply switch, inputs the number of connections and the connection procedure of the second workpiece W2 by an operation button on the operation panel 2, and presses a start button, as shown in FIG. 12, the workpiece connecting apparatus 1 moves the welding articulated robot 9, the first pressing articulated robot 3, and the second and third pressing mechanism 7 to initial positions (S1), reads a connection order for connecting the second workpiece W2 to the first workpiece W1 from the connection processing procedure table 50a (S3), reads a first connection position of the second workpiece W2 (S5), and executes the first pressing portion selection program (S7).

In the first pressing portion selection program, as shown in FIG. 13, a current state (an initial state at first) of the first pressing portion 5 is read from the first pressing portion current state table 50b (S41), the next pressing position (here, the back surface position of the first workpiece W1 facing a first connection position Pd of the second workpiece W2) is read from the connection processing procedure table 50a (S43), and the inclination information of the next pressing position (the back surface position of the first workpiece W1 facing the first connection position Pd of the second workpiece W2) is read (S45).

Then, a first plate (here, it is assumed that 53m is selected) of the first pressing portion 5 at the next pressing position is selected (S47) based on the current state (the initial state) of the first pressing portion 5, the next pressing position (the back surface position of the first workpiece W1 facing the first connection position Pd of the second workpiece W2), and the inclination information of the next pressing position (the back surface position of the first workpiece W1 facing the first connection position of the second workpiece W2), and the processing returns to the connection processing program (S49).

Since the first pressing portion 5 of the present embodiment is connected to the distal end of the first pressing articulated robot 3, the first pressing portion 5 is capable of moving to any angle, and the selection of the first plate at the next pressing position is not limited to one in some cases.

However, even in such a case, one optimal first plate is selected in consideration of a distance of movement and an amount of angle of rotation.

In the present embodiment, for convenience of description, as described above, it is assumed that the first connection position of the second workpiece W2 is Pd and a first plate 53m is first selected by the first pressing portion selection program.

FIG. 15 shows a state before the ultrasonic transducer 20 of the welding articulated robot 9 and the first pressing portion 5 of the first pressing articulated robot 3 abut on the first workpiece W1 and the second workpiece W2.

Returning to the connection processing program, when the processing of S49 is completed, the selected first plate 55m of the first pressing portion 5 is abutted on the back surface of the connection position Pd of the first workpiece W1 (S9), and then the welding articulated robot 9 is operated to urge the second workpiece W2 against the first workpiece W1 by the ultrasonic transducer 20 and the first plate 55m of the first pressing portion 5, thereby the second workpiece W2 is ultrasonically welded at the connection position Pd of the first workpiece W1 (S11).

FIG. 16 shows a state in which the selected first plate 5m of the first pressing portion 5 is abutted on the back surface of the connection position Pd of the first workpiece W1 in a state which the ultrasonic transducer 20 is separated from the connection position Pd of the first workpiece W1, and FIGS. 17 and 18 show a state in which the welding articulated robot 9 is operated thereafter to press the first workpiece W1 and the second workpiece W2 by the ultrasonic transducer 20 and the first plate 5m of the first pressing portion 5, and to ultrasonically weld the second workpiece W2 at the connection position Pd of the first workpiece W1 (S11).

On the other hand, FIG. 19 shows a state in which a first plate 55e of the first pressing portion 5 is selected by the first pressing portion selection program, the first plate 55c is abutted on the back surface of another connection position of the first workpiece W1, and then the welding articulated robot 9 is operated to urge the second workpiece W2 against the another connection position of the first workpiece W1 by the ultrasonic transducer 20 and the first plate 55e of the first pressing portion 5, and to ultrasonically weld the second workpiece W2 at the connection position of the first workpiece W1.

After the ultrasonic welding, the ultrasonic transducer 20 and a first plate 5m of the first pressing portion 5 are separated from each other (S13), it is judged whether or not all the connections by the first pressing portion 5 are completed (S15), and in a case where it is judged that all the connections by the first pressing portion 5 are not completed (S15: No), a next connection position of the second workpiece W2 is read from the connection processing procedure table 50a (S17), and the processing from S7 to S15 is repeated.

On the other hand, when it is judged that all the connections by the first pressing portion 5 are completed (S15: Yes), a next connection position of the second workpiece W2 (here, the back surface position of the first workpiece W1 facing the connection position Pc of the second workpiece W2) is read from the connection processing procedure table 50a (S19), the second pressing portion 7a or the third pressing portion 7b closer to the connection position is selected (S21), and the second pressing portion etc. operation program is executed (S23).

In the present embodiment, for convenience of description, it is described that the second pressing portion 7a is selected by the processing of S21, but even in a case where the third pressing portion 7b is selected, the operation of the third pressing portion is the same as the operation of the second pressing portion 7a to be described later except that the contact position is different.

In addition, in the present embodiment, as described above, the connection position of the second workpiece W2 will be described as Pc.

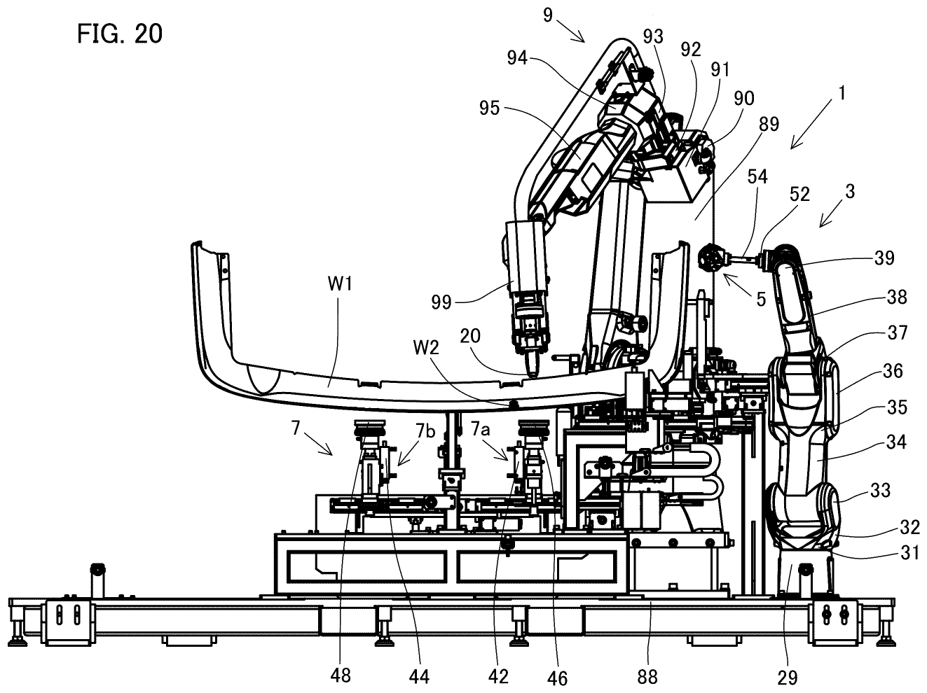

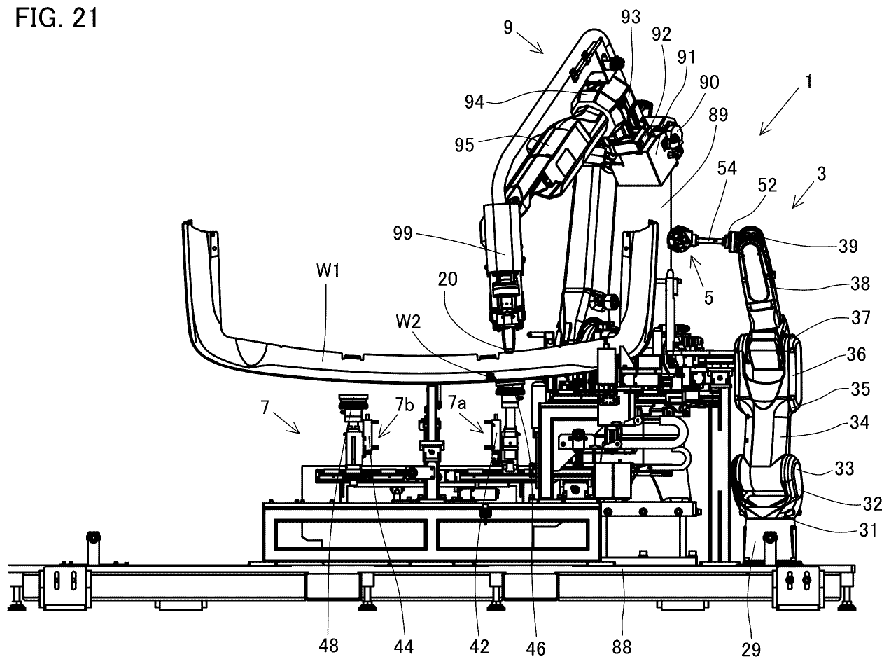

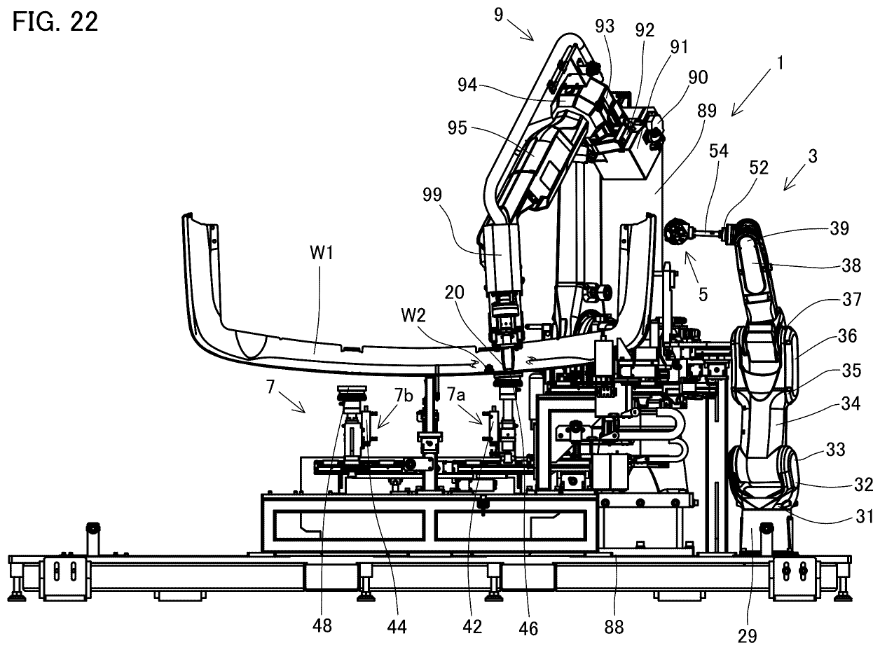

FIG. 20 is a view showing a state of a first stage of the second pressing portion in the workpiece connecting apparatus of the present embodiment, FIG. 21 is a view showing a state of a second stage of the second pressing portion, and FIG. 22 is a view showing a state of a final stage of the second pressing portion.

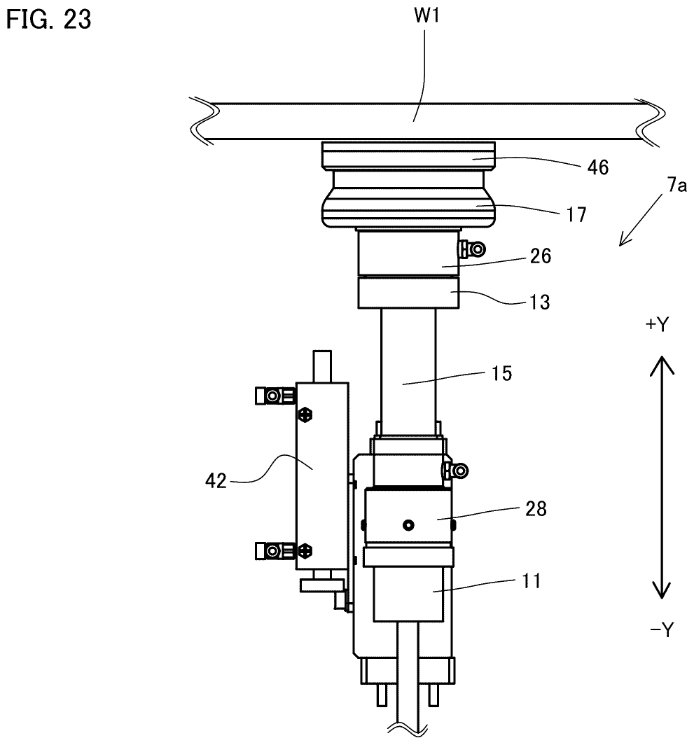

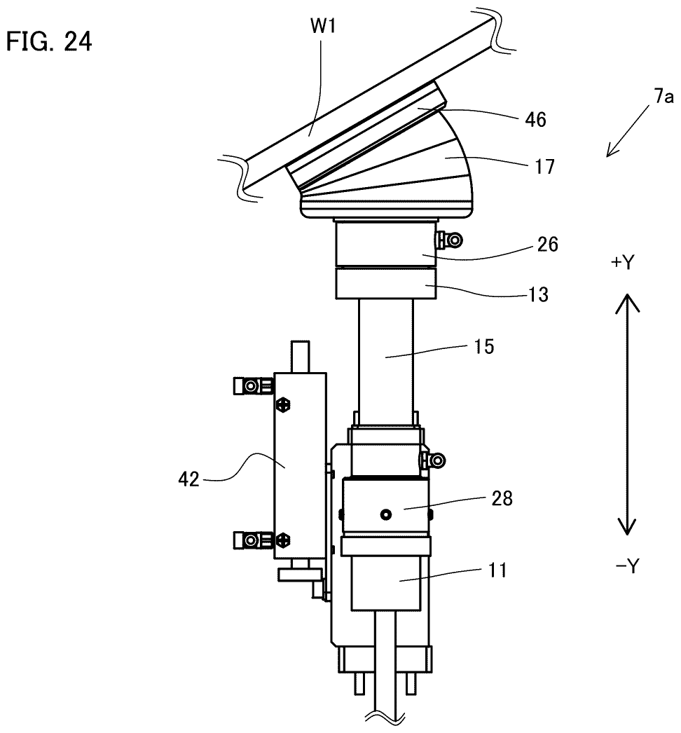

In addition, FIG. 23 is a side view showing a state in which the second pressing portion of the present embodiment abuts against the horizontal surface of the first workpiece, and FIG. 24 a side view showing a state in which the second pressing portion abuts against the inclined surface of the first workpiece.

In the second pressing portion etc. operation program, as shown in FIG. 14, the selected second pressing portion 7a is moved to below the connection position Pc by using a second pressing slide motor 22 (S51), the second vertical fixing solenoid valve 28 is released, the second base portion 13, the second swing fixing solenoid valve 26, the telescopic portion 17, and the second pressing suction portion 46 are raised in the +Y direction (see FIG. 8) by the force of the compression spring (S53), and the second pressing suction portion 46 is abutted on the back surface of the first workpiece W1 (S55).

FIG. 20 shows a state before the ultrasonic transducer 20 of the welding articulated robot 9 and the second pressing portion 7a of the second and third pressing mechanism 7 abut on the first workpiece W1 and the second workpiece W2, and FIG. 21 shows a state where the second pressing portion 7a of the second and third pressing mechanism 7 abuts on the back surface of the connection position Pc of the first workpiece W1.

In addition, in a state in which the second pressing portion 7a is abutted on the back surface of the connection position of the first workpiece W1, the second swing fixing solenoid valve 26 is released, and the telescopic portion 17 and the second pressing suction portion 46 are not fixed and are in a swingable state.

Therefore, in a case where the first workpiece W1 is a horizontal plane, as shown in FIG. 23, the telescopic portion 17 and the second pressing suction portion 46 abut on along the horizontal plane of the first workpiece W1 by the force of the compression spring, and in a case where the first workpiece W1 is an inclined plane, as shown in FIG. 24, the second pressing suction portion 46 abuts on along the inclined plane of the first workpiece W1 by the force of the compression spring in a state where the telescopic portion 17 is deformed.

Then, after the second pressing suction portion 46 is abutted on the back surface of the first workpiece W1 (S55), the telescopic rod 15 is fixed in the contact state by the second vertical fixing solenoid valve 28, the telescopic portion 17 and the second pressing suction portion 46 are fixed in the contact state by the second swing fixing solenoid valve 26 (S57), and the processing returns to the connection processing program (S59).

At this time, the second pressing suction portion 46 may be sucked by the air compressor 4 to improve an adhesion degree between the first workpiece W1 and the second pressing suction portion 46. In this case, the second pressing portion 7a is able to be more firmly fixed to the first workpiece W1.

In addition, in a case where the third pressing portion 7b is used, the third pressing suction portion 48 may be sucked by the air compressor 4 to improve the adhesion degree between the first workpiece W1 and the third pressing suction portion 48. Also in this case, similarly to the second pressing portion 7a, the third pressing portion 7b is able to be more firmly fixed to the first workpiece W1.

Returning to the connection processing program, when the processing of S59 is completed, the welding articulated robot 9 is operated to urge the second workpiece W2 against the first workpiece W1 by the ultrasonic transducer 20 and the second pressing suction portion 46 of the second pressing portion 7a, and to ultrasonically weld the second workpiece W2 at the connection position Pc of the first workpiece W1 (S25).

FIG. 22 shows a state in which the welding articulated robot 9 is operated to urge the second workpiece W2 against the first workpiece W1 by the ultrasonic transducer 20 and the second pressing suction portion 46 of the second pressing portion 7a, and to ultrasonically weld the second workpiece W2 at the connection position Pc of the first workpiece W1.

After the ultrasonic welding, the ultrasonic transducer 20 and the second pressing suction portion 46 of the second pressing portion 7a are separated from each other (S27), and it is judged whether or not all the connections by the second pressing portion 7a and the third pressing portion 7b are completed (S29), if it is judged that all the connections by the second pressing portion 7a and the third pressing portion 7b are not completed (S29: No), a next connection position of the second workpiece W2 is read from the connection processing procedure table 50a (S31), and the processing from S21 to S29 is repeated.

On the other hand, when it is judged that all the connections by the second pressing portion 7a and the third pressing portion 7b are completed (S29: Yes), the processing is finished (S33).

When the third pressing portion 7b is selected, similarly to the second pressing portion 7a, firstly, the selected third pressing portion 7b is moved to below the connection position by using the third pressing slide motor 24, the third vertical fixing solenoid valve 40 is released, the second base portion 13, the third swing fixing solenoid valve 30, the telescopic portion 17, and the third pressing suction portion 48 are raised in the +Y direction (see FIG. 8) by the force of the compression spring, and the third pressing suction portion 48 is abutted on the back surface of the first workpiece W1.

Then, after the third pressing suction portion 48 is abutted on the back surface of the first workpiece W1, the telescopic rod 15 is fixed in the contact state by the third vertical fixing solenoid valve 40, and the telescopic portion 17 and the third pressing suction portion 48 are fixed in the contact state by the third swing fixing solenoid valve 30.

According to the workpiece connecting apparatus 1 of the present embodiment, since the workpiece connecting apparatus 1 for connecting the second workpiece W2 to the front surface of the first workpiece W1 by urging the second workpiece W2 against the front surface of the first workpiece W1 includes, in particular, the first pressing articulated robot 3 and the supporting body 51 connected to the distal end of the first pressing articulated robot 3 and capable of being abutted on the back surface of the first workpiece W1, even if the first workpiece W1 has a complicated shape, an appropriate supporting body 51 is capable of being abutted on the back surface of the first workpiece W1, and ultimately the second workpiece W2 is capable of being quickly connected to the front surface of the first workpiece W1.

In addition, according to the workpiece connecting apparatus 1 of the present embodiment, since the supporting body 51 includes a plurality of first plates 53a, 53b, 53c, 53d, 53c, 53f, 53g, 53h, 53j, 53k and 53m disposed so that the normal lines of the first plates are oriented in a plurality of directions, even if the first workpiece W1 has a complicated shape, an appropriate first plate is capable of being selected and abutted on the back surface of the first workpiece W1, and ultimately the second workpiece W2 is capable of being efficiently connected to the front surface of the first workpiece W1. In addition, even when one first plate is not able to be used, another first plate is able to be used, so that the durability of the apparatus is capable of being improved.

In addition, according to the workpiece connecting apparatus 1 of the present embodiment, since a polyhedron is connected to the distal end of the first pressing articulated robot 3, and each of the first plates 53a, 53b, 53c, 53d, 53e, 53f, 53g, 53h, 53j, 53k and the 53m is separately connected to one of the faces constituting the polyhedron, it is possible to easily manufacture a structure in which an appropriate first plate is capable of being selected and abutted on the first workpiece W1 having a complicated shape.

In addition, according to the workpiece connection apparatus 1 of the present embodiment, since the polyhedron includes the opening surface 51b and the cavity 51c therein, and each of the plurality of first plates 53a, 53b, 53c, 53d, 53e, 53f, 53g, 53h, 53j, 53k and 53m is clamped to the polyhedron by the fastener 58aa (not shown), 58ba, 58ca, 58da (not shown), 58ca, 58fa, 58ga, 58ha, 58ja, 58ka or 58ma from the cavity 51c, and is separately connected to one face of faces constituting the polyhedron, it is possible to easily create a structure in which an appropriate first plate is capable of being selected and firmly abutted on the first workpiece W1 having a complicated shape.

In addition, according to the workpiece connecting apparatus 1 of the present embodiment, since each of the first plates 53a, 53b, 53c, 53d, 53c, 53f, 53g, 53h, 53j, 53k and 53m includes the protruding portion 57a (not shown), 57b, 57c, 57d (not shown), 57c, 57f, 57g, 57h, 57j (not shown), 57k, or 57m which has a circular shape in plan view and of which a central portion protrudes, it is possible to prevent distortion occurring on the front surfaces of the first workpiece W1 and/or on the front surfaces of the second workpiece W2 during welding, and to improve the appearance of the entire workpiece including the first workpiece W1 and the second workpiece W2.

Furthermore, according to the workpiece connecting apparatus 1 of the present embodiment, in the workpiece connecting apparatus 1 that urges a second workpiece W2 against the front surface of a first workpiece W1 and connects the second workpiece W2 to the front surface of the first workpiece W1, in particular, since the workpiece connecting apparatus 1 includes one movable second pressing suction portion 46 or third pressing suction portion 48 that capable of abutting on the back surface of the first workpiece W1 and of which a normal line is capable of changing in a plurality of directions, wherein the second pressing suction portion 46 or the third pressing suction portion 48 is capable of fixing its normal direction when the second pressing suction portion 46 or the third pressing suction portion 48 abuts on the back surface of the first workpiece W1, even if the first workpiece W1 has a complicated shape, the second pressing suction portion 46 or the third pressing suction portion 48 is capable of being appropriately abutted on the back surface of the first workpiece W1, and ultimately the second workpiece W2 is capable of being quickly connected to the front surface of the first workpiece W1.

### Second Embodiment

Next, a second embodiment of the present invention will be described.

The drawings used in the present embodiment are also exaggerated for easy understanding, and the dimensions thereof are different from the actual dimensions.

Hereinafter, a second embodiment of the present invention will be described, but since a workpiece connection apparatus 21 of the present embodiment is the same as the workpiece connection apparatus 1 of the first embodiment except for the first pressing portion, the same reference numerals are given to the portions common to the first embodiment, and the description thereof will be omitted.

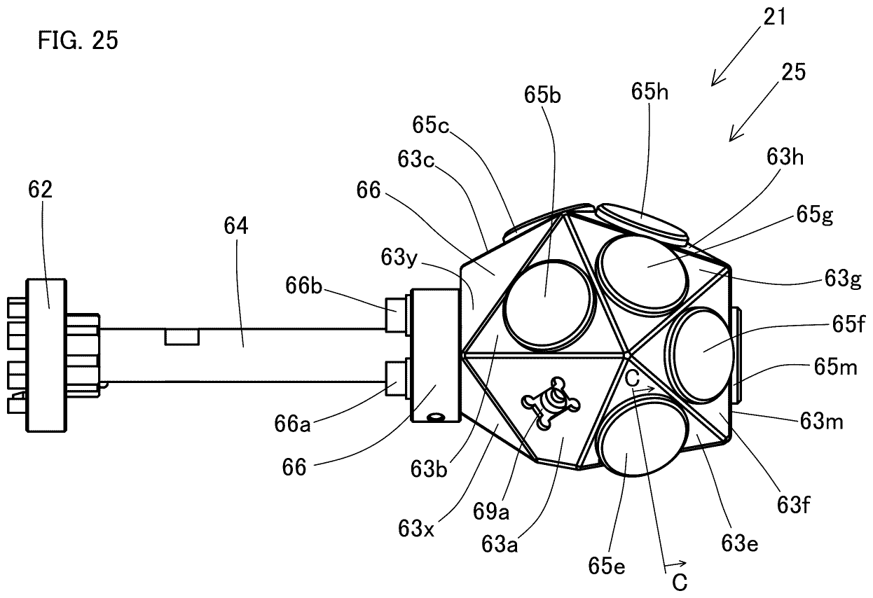

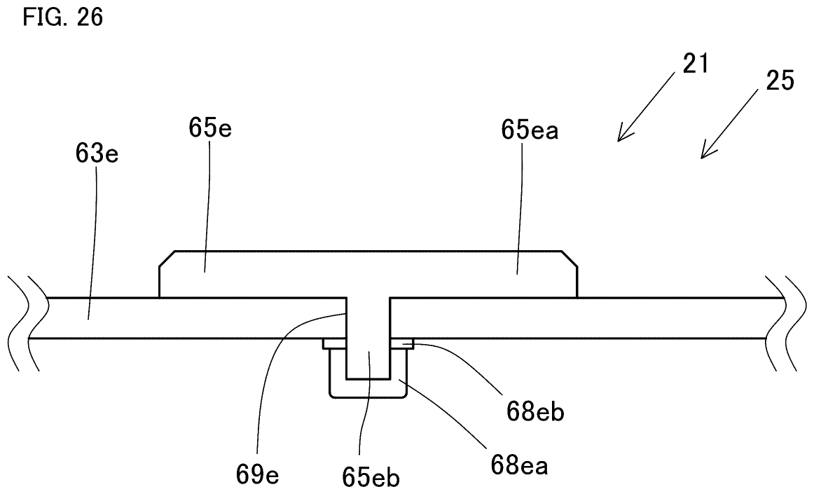

FIG. 25 is a left side view of the first pressing portion of the second embodiment, and FIG. 26 is a cross-sectional view taken along line C-C of FIG. 25.

Similarly to the workpiece connecting apparatus 1 of the first embodiment, the workpiece connecting apparatus 21 of the present embodiment also uses the welding articulated robot 9, the first pressing articulated robot 3, and the second and third pressing mechanism 7 to urge the second workpiece W2 against the first workpiece W1 fixed on the mounting table 88 disposed in the housing H and to connect the second workpiece W2 to the first workpiece W1.

In addition, similarly to the first pressing portiont 5 of the first embodiment, a first pressing portion 25 of the present embodiment presses the back surface of the first workpiece W1 when the welding articulated robot 9 welds the second workpiece W2 to the first workpiece W1.

As shown in FIG. 25, the first pressing portion 25 of the present embodiment includes a first attachment portion 62 connected to a fifth rotation shaft 39 of the first pressing articulated robot 3, a long arm portion 64 having one end connected to the first attachment portion 62, a second attachment portion 66 connected to the other end of the long arm portion 64 by five attachment tools 66a, 66b, 66c, 66d and 66e (66c to 66e are not shown), and a supporting body 66 connected to the second attachment portion 66.

The supporting body 66 is formed of a polyhedron including fourteen first plates 63a, 63b, 63c, 63d (not shown), 63c, 63f, 63g, 63h, 63j (not shown), 63k (not shown), 63m, 63x, 63y and 63z (not shown) having a substantially triangular flat plate shape each, and circular flat plates 65a (not shown), 65b, 65c, 65d (not shown), 65c, 65f, 65g, 65h, 65j (not shown), 65k (not shown) or 65m having a predetermined thickness each is fixed on the front surface of each of the first plates except for 63x, 63y and 63z in the polyhedron within the substantially triangular outer periphery of the first plate.

In FIG. 25, in order to make it easy to understand an assembly of the first pressing portion 25, a state before a disk 65a is attached is illustrated in the first plate 63a, but actually, the disk 65a is attached to the first plate 63a similarly to the other first plates.

In addition, the normal lines of the first plates 63a, 63b, 63c, 63d, 63c, 63f, 63g, 63h, 63j, 63k, 63m, 63x, 63y and 63z are arranged so as to be oriented in different directions.

Similarly to the supporting body 51 of the first embodiment, the supporting body 66 also includes an opening surface 61b (not shown) formed by a housing 61a (not shown) and a cavity 61c (not shown) formed inside the polyhedron, and as shown in FIG. 26, each of disks 65a (not shown), 65b, 65c, 65d (not shown), 65c, 65f, 65g, 65h, 65j (not shown), 65k (not shown) and 65m includes a disk body 65aa, 65ba, 65ca, 65da, 65ca, 65fa, 65ga, 65ha, 65ja, 65ka and 65ma (not shown except for 65ca), and a screw portion 65ab, 65bb, 65cb, 65db, 65eb, 65fb, 65gb, 65hb, 65jb, 65kb and 65mb (not shown except for 65cb) extending from the disk body.

Then, each of the disks 65a (not shown), 65b, 65c, 65d (not shown), 65, 65f, 65g, 65h, 65j (not shown), 65k (not shown) and 65m is individually clamped by the fasteners 68aa, 68ba, 68ca, 68da, 68ca, 68fa, 68ga, 68ha, 68ja, 68ka or 68ma (not shown except for 68ca) from a cavity 61c and washers 68ab, 68bb, 68cb, 68db, 68cb, 68fb, 68gb, 68hb, 68jb, 68kb or 68mb (not shown except for 68eb) via holes 69a, 69b, 69c, 69d, 69e, 69f, 69g, 69h, 69j, 69k or 69m (not shown except for 69e) of the first plates 63a, 63b, 63c, 63d, 63e, 63f, 63g, 63h, 63j, 63k or 63m

In the first pressing portion 25 of the present embodiment, a disk selected by the above-described first pressing portion selection program in the disks 65a, 65b, 65c, 65d, 65e, 65f, 65g, 65h, 65j, 65k and 65m abuts on the back surface of the first workpiece W1.

According to the workpiece connection apparatus 21 of the present embodiment, since the workpiece connection apparatus 21 for connecting the second workpiece W2 to the front surface of the first workpiece W1 by urging the second workpiece W2 against the front surface of the first workpiece W1 includes, in particular, the first pressing articulated robot 3 and the supporting body 66 connected to the distal end of the first pressing articulated robot 3 and capable of being abutted on the back surface of the first workpiece W1, even if the first workpiece W1 has a complicated shape, an appropriate supporting body 66 is capable of being abutted on the back surface of the first workpiece W1, and ulitmately the second workpiece W2 is capable of being quickly connected to the front surface of the first workpiece W1.

In addition, according to the workpiece connection apparatus 21 of the present embodiment, since the supporting body 66 includes a plurality of first plates 63a, 63b, 63c, 63d, 63e, 63f, 63g, 63h, 63j, 63k and 63m disposed so that the normal lines of the first plates are oriented in a plurality of directions, even if the first workpiece W1 has a complicated shape, an appropriate first plate is capable of being selected and abutted on the back surface of the first workpiece W1, and ultimately the second workpiece W2 is capable of being efficiently connected to the front surface of the first workpiece W1. In addition, even when one first plate is not able to be used, another first plate is able to be used, so that the durability of the apparatus is capable of being improved.

In addition, according to the workpiece connecting apparatus 21 of the present embodiment, since a polyhedron is connected to the distal end of the first pressing articulated robot 3, and each of the first plates 63a, 63b, 63c, 63d, 63e, 63f, 63g, 63h, 63j, 63k and 63m is separately connected to one of the faces constituting the polyhedron, it is possible to easily manufacture a structure in which an appropriate first plate is capable of being selected and abutted on the first workpiece W1 having a complicated shape.

Furthermore, according to the workpiece connection apparatus 21 of the present embodiment, since the polyhedron includes the opening surface 61b (not shown) and the cavity 61c (not shown) therein, and each of the plurality of the disks 65a, 65b, 65c, 65d, 65e, 65f, 65g, 65h, 65j, 65k and 65m is clamped to the first plate 63a, 63b, 63c, 63d, 63e, 63f, 63g, 63h, 63j, 63k or 63m by the fastener 68aa, 68ba, 68ca, 68da, 68ea, 68fa, 68ga, 68ha, 68ja, 68ka or 68ma (not shown except for 68ea) from the cavity 61c, and is separately connected to one face constituting the polyhedron, it is possible to easily create a structure in which an appropriate first plate is capable of being selected and firmly abutted on the first workpiece W1 having a complicated shape.

### Third Embodiment

Next, a third embodiment of the present invention will be described. The drawings used in the present embodiment are also exaggerated for easy understanding, and the dimensions thereof are different from the actual dimensions.

Hereinafter, a third embodiment of the present invention will be described, but since a workpiece connection apparatus 61 of the present embodiment is the same as the workpiece connection apparatus 1 of the first embodiment except for the first pressing portion, the same reference numerals are given to the portions common to the first embodiment, and the description thereof will be omitted.

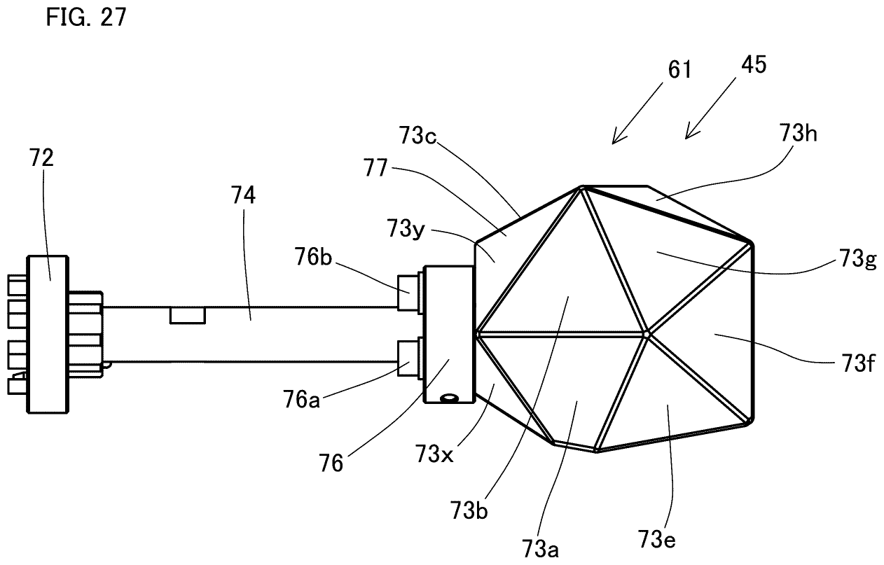

FIG. 27 is a left side view of the first pressing portion of the third embodiment.

Similarly to the workpiece connecting apparatus 1 of the first embodiment, the workpiece connecting apparatus 61 of the present embodiment also uses the welding articulated robot 9, the first pressing articulated robot 3, and the second and third pressing mechanism 7 to urge the second workpiece W2 against the first workpiece W1 fixed on the mounting table 88 disposed in the housing H and to connect the second workpiece W2 to the first workpiece W1.

In addition, similarly to the first pressing portion 5 of the first embodiment, a first pressing portion 45 of the present embodiment presses the back surface of the first workpiece W1 when the welding articulated robot 9 welds the second workpiece W2 to the first workpiece W1.

As shown in FIG. 27, the first pressing portion 45 of the present embodiment includes a first attachment portion 72 connected to the fifth rotation shaft 39 of the first pressing articulated robot 3, a long arm portion 74 having one end connected to the first attachment portion 72, a second attachment portion 76 connected to the other end of the long arm portion 74 by five attachment tools 76a, 76b, 76c, 76d and 76e (76c to 76e are not shown), and a supporting body 77 connected to the second attachment portion 76.

The supporting body 77 is formed of a polyhedron including fourteen first plates 73a, 73b, 73c, 73d (not shown), 73e, 73f, 73g, 73h, 73j (not shown), 73k (not shown), 73m (not shown), 73x, 73y and 73z (not shown) having a substantially triangular flat shape each.

In addition, the normal lines of the first plates 73a, 73b, 73c, 73d, 73e, 73f, 73g, 73h, 73j, 73k, 73m, 73x, 73y and 73z are arranged so as to be oriented in different directions.

Similarly to the supporting body 51 of the first embodiment, the supporting body 77 also includes an opening surface 71b (not shown) formed by a housing 71a (not shown) and a cavity 71c (not shown) formed inside the polyhedron.

In the first pressing portion 45 of the present embodiment, the first plate selected by the above-described first pressing portion selection program in the first plates 73a, 73b, 73c, 73d, 73e, 73f, 73g, 73h, 73j, 73k and 73m abuts on the back surface of the first workpiece W1.

According to the workpiece connection apparatus 61 of the present embodiment, since the workpiece connection apparatus 61 for connecting the second workpiece W2 to the front surface of the first workpiece W1 by urging the second workpiece W2 against the front surface of the first workpiece W1 includes, in particular, the first pressing articulated robot 3 and the supporting body 77 connected to the distal end of the first pressing articulated robot 3 and capable of being abutted on the back surface of the first workpiece W1, even if the first workpiece W1 has a complicated shape, an appropriate supporting body 77 is capable of being abutted on the back surface of the first workpiece W1, and ulitmately the second workpiece W2 is capable of being quickly connected to the front surface of the first workpiece W1.

In addition, according to the workpiece connection apparatus 61 of the present embodiment, since the supporting body 77 is formed of a plurality of first plates 73a, 73b, 73c, 73d, 73e, 73f, 73g, 73h, 73j, 73k and 73m disposed so that the normal lines are oriented in the plurality of directions, even if the first workpiece W1 has a complicated shape, an appropriate first plate is capable of being selected and abutted on the back surface of the first workpiece W1, and ultimately the second workpiece W2 is capable of being efficiently connected to the front surface of the first workpiece W1. In addition, even when one first plate is not abale to be used, another first plate is able to be used, so that the durability of the apparatus is capable of being improved.

Furthermore, according to the workpiece connecting apparatus 61 of the present embodiment, since the polyhedron is connected to the distal end of the first pressing articulated robot 3, and each of the first plates 73a, 73b, 73c, 73d, 73e, 73f, 73g, 73h, 73j, 73k and 73m is separately connected to one of the faces constituting the polyhedron, it is possible to easily create a structure in which an appropriate first plate is capable of being selected and abutted on the first workpiece W1 having a complicated shape.

### Fourth Embodiment

Next, a fourth embodiment of the present invention will be described. The drawings used in the present embodiment are also exaggerated for easy understanding, and the dimensions thereof are different from the actual dimensions.

Hereinafter, a fourth embodiment of the present invention will be described, but since a workpiece connection apparatus 71 of the present embodiment is the same as the workpiece connection apparatus 1 of the first embodiment except for the first pressing portion, the same reference numerals are given to the portions common to the first embodiment, and the description thereof will be omitted.

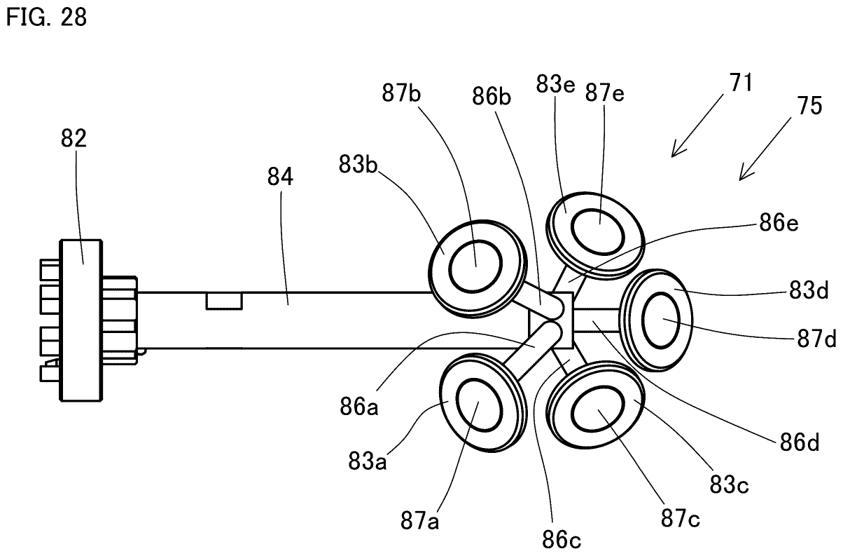

FIG. 28 is a left side view of the first pressing portion of the fourth embodiment.

Similarly to the workpiece connecting apparatus 1 of the first embodiment, the workpiece connecting apparatus 71 of the present embodiment also uses the welding articulated robot 9, the first pressing articulated robot 3, and the second and third pressing mechanism 7 to urge the second workpiece W2 against the first workpiece W1 fixed on the mounting table 88 disposed in the housing H and to connect the second workpiece W2 to the first workpiece W1.

In addition, similarly to the first pressing portion 5 of the first embodiment, a first pressing portion 75 of the present embodiment presses the back surface of the first workpiece W1 when the welding articulated robot 9 welds the second workpiece W2 to the first workpiece W1.

As shown in FIG. 28, the first pressing portion 75 of the present embodiment includes a first attachment portion 82 connected to the fifth rotation shaft 39 of the first pressing articulated robot 3, a long arm portion 84 having one end connected to the first attachment portion 82, five shafts 86a, 86b, 86c, 86d and 86e connected to the other end of the long arm portion 84, disk-shaped first plates (corresponding to “supporting body” of the present invention) 83a, 83b, 83c, 83d and 83e having a predetermined thickness and respectively connected to the distal ends of the five shafts 86a, 86b, 86c, 86d and 86e, and protruding portions 87a, 87b, 87c, 87d and 87e having a circular shape in plan view, which are respectively disposed on the surfaces of the first plates 83a, 83b, 83c, 83d and 83e and whose central portions protrude in a radial direction with respect to the long arm portion 84.

In addition, the normal lines of the disk-shaped first plates (corresponding to “supporting body” of the present invention) 83a, 83b, 83c, 83d and 83e are arranged so as to be oriented in different directions.

In the first pressing portion 75 of the present embodiment, the first plate (supporting body) selected by the above-described first pressing portion selection program in the first plates (corresponding to “supporting body” of the present invention) 83a, 83b, 83c, 83d and 83e abuts on the back surface of the first workpiece W1.

According to the workpiece connection apparatus 71 of the present embodiment, since the workpiece connection apparatus 71 for connecting the second workpiece W2 to the front surface of the first workpiece W1 by urging the second workpiece W2 against the front surface of the first workpiece W1 includes, in particular, the first pressing articulated robot 3 and the supporting bodies 83a, 83b, 83c, 83d and 83e connected to the distal end of the first pressing articulated robot 3 and capable of being abutted on the back surface of the first workpiece W1, even if the first workpiece W1 has a complicated shape, an appropriate supporting body 83a, 83b, 83c, 83d or 83e is capable of being abutted on the back surface of the first workpiece W1, and ulitmately the second workpiece W2 is capable of being quickly connected to the front surface of the first workpiece W1.

In addition, according to the workpiece connecting apparatus 71 of the present embodiment, since the first plates 83a, 83b, 83c, 83d and 83e are arranged so that the normal lines are oriented in a plurality of directions, even if the first workpiece W1 has a complicated shape, an appropriate first plate is capable of being selected and abutted on the back surface of the first workpiece W1, and ultimately the second workpiece W2 is capable of being efficiently connected to the front surface of the first workpiece W1. In addition, even when one first plate is not abale to be used, another first plate is able to be used, so that the durability of the apparatus is capable of being improved.

Furthermore, according to the workpiece connecting apparatus 71 of the present embodiment, since each of the first plates 83a, 83b, 83c, 83d and 83e includes the protruding portion 87a, 87b, 87c, 87d or 87e having a circular shape in plan view and whose central portion protrudes, it is possible to prevent distortion occurring on the front surface of the first workpiece W1 and/or the front surface of the second workpiece W2 during welding, and to improve the appearance of the entire workpiece including the first workpiece W1 and the second workpiece W2.

### Fifth Embodiment

Next, a fifth embodiment of the present invention will be described. The drawings used in the present embodiment are also exaggerated for easy understanding, and the dimensions thereof are different from the actual dimensions.

Hereinafter, a fifth embodiment of the present invention will be described, but since a workpiece connection apparatus 81 of the present embodiment is the same as the workpiece connection apparatus 1 of the first embodiment except for the first pressing portion, the same reference numerals are given to the portions common to the first embodiment, and the description thereof will be omitted.

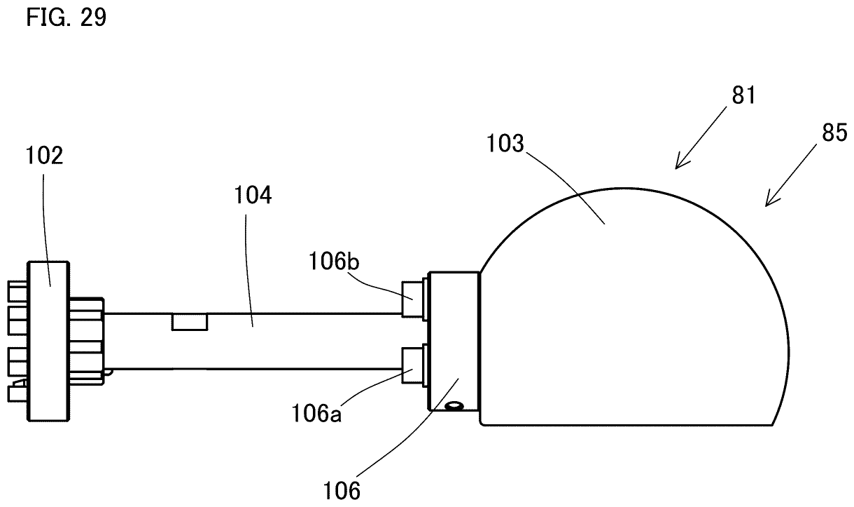

FIG. 29 is a left side view of the first pressing portion of the fifth embodiment.

Similarly to the workpiece connecting apparatus 1 of the first embodiment, the workpiece connecting apparatus 81 of the present embodiment also uses the welding articulated robot 9, the first pressing articulated robot 3, and the second and third pressing mechanism 7 to urge the second workpiece W2 against the first workpiece W1 fixed on the mounting table 88 disposed in the housing H and to connect the second workpiece W2 to the first workpiece W1.

In addition, similarly to the first pressing portion 5 of the first embodiment, the first pressing portion 85 of the present embodiment presses the back surface of the first workpiece W1 when the welding articulated robot 9 welds the second workpiece W2 to the first workpiece W1.

As shown in FIG. 29, the first pressing portion 85 of the present embodiment includes a first attachment portion 102 connected to the fifth rotation shaft 39 of the first pressing articulated robot 3, a long arm portion 104 having one end connected to the first attachment portion 102, a second attachment portion 106 connected to the other end of the long arm portion 104 by five attachment tools 106a, 106b, 106c, 106d and 106e (106c to 106e are not shown), and a supporting body 103 connected to the second attachment portion 106.

The supporting body 103 has a hemispherical shape.

Then, the first pressing portion 85 of the present embodiment abuts so that the normal line of the front surface of the supporting body 103 coincides with the normal line of the back surface of the first workpiece W1.

According to the workpiece connection apparatus 81 of the present embodiment, since the workpiece connection apparatus 81 for connecting the second workpiece W2 to the front surface of the first workpiece W1 by urging the second workpiece W2 against the front surface of the first workpiece W1 includes, in particular, the first pressing articulated robot 3 and the supporting body 103 connected to the distal end of the first pressing articulated robot 3 and capable of being abutted on the back surface of the first workpiece W1, even if the first workpiece W1 has a complicated shape, the supporting body 103 is capable of being abutted on the back surface of the first workpiece W1, and ulitmately the second workpiece W2 is capable of being quickly connected to the front surface of the first workpiece W1.

### Sixth Embodiment

Finally, a sixth embodiment of the present invention will be described. The drawings used in the present embodiment are also exaggerated for easy understanding, and the dimensions thereof are different from the actual dimensions.

Hereinafter, a sixth embodiment of the present invention will be described, but since a workpiece connection apparatus 101 of the present embodiment is the same as the workpiece connection apparatus 1 of the first embodiment except for the second pressing portion and the third pressing portion, the same reference numerals are given to the portions common to the first embodiment, and the description thereof will be omitted.

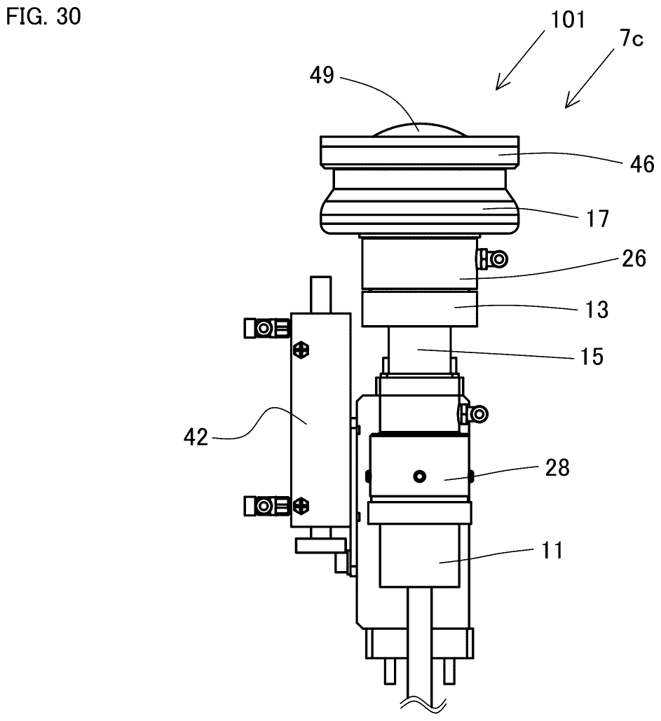

FIG. 30 is a side view showing a second pressing portion of the sixth embodiment.

Similarly to the workpiece connecting apparatus 1 of the first embodiment, the workpiece connecting apparatus 101 of the present embodiment also uses the welding articulated robot 9, the first pressing articulated robot 3, and the second and third pressing mechanism 7 to urge the second workpiece W2 against the first workpiece W1 fixed on the mounting table 88 disposed in the housing H and to connect the second workpiece W2 to the first workpiece W1.

In addition, similarly to the second pressing portion 7a of the first embodiment, the second pressing portion 7c of the present embodiment presses the back surface of the first workpiece W1 when the welding articulated robot 9 welds the second workpiece W2 to the first workpiece W1.

As shown in FIG. 30, the second pressing portion 7c includes a first base portion 11, a telescopic rod 15 extending and contracting with respect to the first base portion 11, a compression spring (not shown) disposed inside the telescopic rod 15 and urges the telescopic rod 15 upward, a second pressing cylinder 42 extending and contracting the telescopic rod 15 with respect to the first base portion 11, a second vertical fixing solenoid valve 28 disposed on an upper portion of the first base portion 11 and fixing a vertical position of the telescopic rod 15, a second base portion 13 fixed on an upper end of the telescopic rod 15, a swing fixing solenoid valve 26 disposed on an upper portion of the second base portion 13 and fixing the swing of the second pressing suction portion 46 to be described later, the extensible and contractible telescopic portion 17 disposed on an upper portion of the swing fixing solenoid valve 26, the second pressing suction portion 46 (corresponding to “second plate” of the present invention) disposed on an upper portion of the telescopic portion 17, and a protruding portion 49 disposed on the suction portion 46 and whose central portion protrudes.

Similarly to the second pressing portion 7a of the first embodiment,

In the second pressing portion 7c configured as described above, firstly, the second base portion 13, the second swing fixing solenoid valve 26, the telescopic portion 17, and the second pressing suction portion 46 are lowered in the −rection by the second pressing cylinder 42, and thereafter, the telescopic rod 15 is fixed at the lowered position in a state where the compression spring is compressed by the second vertical fixing solenoid valve 28.

Thereafter, when the second pressing portion 7c is selected by the second pressing portion etc. operation program, the second pressing portion 7c is moved to below the connection position using the second pressing slide motor 22, the second vertical fixing solenoid valve 28 is released, the second base portion 13, the second swing fixing solenoid valve 26, the telescopic portion 17, the second pressing suction portion 46, and the protruding portion 49 are raised in the +Y direction by the force of the compression spring, and the second pressing suction portion 46 and the protruding portion 49 are abutted on the back surface of the first workpiece W1.

As shown in FIG. 7, the second pressing portion 7c is configured to be movable in the +X direction or the −X direction on the right mounting table 88b fixed to the mounting table 88 by transmitting a rotational force of a motor gear fixed to a motor shaft of the second pressing slide motor 22 to the ball screw by using a second pressing slide motor 22 disposed in the vicinity of the right mounting table 88b and a ball screw disposed inside the right mounting table 88b.

In addition, the second pressing portion 7c may be used instead of the third pressing portion 7b.

According to the workpiece connection apparatus 101 of the present embodiment, since the workpiece connection apparatus 101 for connecting the second workpiece W2 to the front surface of the first workpiece W1 by urging the second workpiece W2 against the front surface of the first workpiece W1 includes, in particular, one movable second pressing suction portion 46 capable of being abutted on the back surface of the first workpiece W1 and whose normal line is capable of being changed in a plurality of directions, and the second pressing suction portion 46 is capable of fixing the direction of the normal line when abutted on the back surface of the first workpiece W1, even if the first workpiece W1 has a complicated shape, an appropriate second pressing suction portion 46 is capable of being abutted on the back surface of the first workpiece W1, and ulitmately the second workpiece W2 is capable of being quickly connected to the front surface of the first workpiece W1.

In addition, according to the workpiece connecting apparatus 101 of the present embodiment, since the second pressing suction portion 46 includes the protruding portion 49 whose central portion protrudes, it is possible to prevent distortion occurring on the front surface of the first workpiece W1 and/or the front surface of the second workpiece W2 during welding, and to improve the appearance of the entire workpiece including the first workpiece W1 and the second workpiece W2.

Although the workpiece connecting apparatus according to various embodiments of the present invention has been described above, the present invention is not limited to the above-described embodiments, and various modifications can be made without departing from the scope of the present invention.

For example, in the above-described embodiments, the case where the second workpiece W2 is ultrasonically welded to the front surface of the first workpiece W1 has been described, but the present invention is not limited thereto, and is capable of being applied to any connections including crimping, pressure welding, and the like as long as the second workpiece W2 is urgued against the first workpiece W1 and connected to the first workpiece W1.

In addition, in the first to third embodiments, the case where the supporting body is a polyhedron having 14 surfaces and the shape of the first plate constituting the polyhedron is a substantially triangular shape has been described, but the present invention is not limited thereto, and the polyhedron may be a polyhedron having two or more surfaces, and a part thereof may be curved. In addition, the shape of the first plate constituting the polyhedron may be any shape.

However, in consideration of ease of control, the shapes of the first plates constituting the polyhedron are preferably unified, and the polyhedron is also preferably constituted by the first plates having the unified shape.

In addition, in the sixth embodiment, The supporting body has been described as a hemispherical form, but the present invention is not limited thereto, for example, the supporting body may have a form in which two or more planes are folded in a V-shape. However, from the viewpoint of effectively pressing the first workpiecce W1, it is better to form the front surfaces of the supporting bodies in a flat shape than to form the front surfaces of the supporting bodies in a curved shape such as a hemispherical shape.

Furthermore, in the above-described embodiments, the second pressing portion 7a and the third pressing portion 7b have been described as moving in a linear direction, but the present invention is not limited thereto, and the moving direction is capable of being appropriately changed according to the specifications of the workpiece connecting apparatus.

According to a first aspect of the present invention is a workpiece connecting apparatus that urges a second workpiece against a front surface of a first workpiece to connect the second workpiece to the front surface of the first workpiece, the workpiece connecting apparatus includes an articulated robot, and a supporting body connected to a distal end of the articulated robot and capable of abutting on a back surface of the first workpiece.

According to a second aspect of the present invention, in the workpiece connecting apparatus according to the first aspect, the supporting body includes a plurality of first plates arranged so that normal lines of the first plates are oriented in a plurality of directions.

According to a third aspect of the present invention, in the workpiece connecting apparatus according to the second aspect, a polyhedron is connected to the distal end of the articulated robot, each of the plurality of first plates is separately connected to one of the faces constituting the polyhedron.

According to a fourth aspect of the present invention, in the workpiece connection apparatus according to the third aspect, the polyhedron includes an opening surface and a cavity therein, each of the plurality of first plates is clamped to the polyhedron by a fastener from the cavity and is separately connected to one of the faces constituting the polyhedron.

According to a fifth aspect of the present invention, in the workpiece connecting apparatus according to any one of the second aspect to the fourth aspect, the first plate has a structure in which a central portion protrudes.

According to a sixth aspect of the present invention, in the workpiece connecting apparatus that urges a second workpiece against a front surface of a first workpiece to connect the second workpiece to the front surface of the first workpiece, the workpiece connecting apparatus including a moving body, and at least one second plate is disposed on the moving body, capable of abutting on a back surface of the first workpiece, and so that a normal line of the at least one second plate is capable of changing in a plurality of directions, wherein the at least one second plate is capable of fixing a normal direction when the at least one second plate abuts against the back surface of the first workpiece.

According to a seventh aspect of the present invention, in the workpiece connecting apparatus according to the sixth aspect, the at least one second plate has a structure in which a central portion protrudes.

### DESCRIPTION OF THE REFERENCE NUMBERS

1,21,61,71,81,101 workpiece connecting apparatus
3 first pressing articulated robot
4 air compressor
5,25,45,75,85 first pressing portion
7 second and third pressing mechanism
7a, 7c second pressing portion
7b third pressing portion
9 welding articulated robot
12 robot controller
20 ultrasonic transducer
22 second pressing slide motor
24 third pressing slide motor
26 second swing fixing solenoid valve
28 second vertical fixing solenoid valve
30 third swing fixing solenoid valve
40 third vertical fixing solenoid valve
42 second pressing cylinder
44 third pressing cylinder
46 second pressing suction portion
48 third pressing suction portion
49,57,87 protruding portion
51,66,77,83,103 supporting body
51b opening surface
51c cavity
53,63,73,83 first plate
55,65 disk
58 fastener
W1 first workpiece
W2 second workpiece

What is claimed is:

1. A workpiece connecting apparatus that urges a second workpiece against a front surface of a first workpiece to connect the second workpiece to the front surface of the first workpiece, the workpiece connecting apparatus comprising:
a first articulated robot; and
a supporting body connected to a distal end of the first articulated robot and including a plurality of first plates disposed so that normal lines of the first plates are oriented in a plurality of directions,
wherein the first articulated robot is configured to select a specific first plate from the plurality of first plates of the supporting body and bring the specific first plate into contact with a back surface of the first workpiece.

2. The workpiece connecting apparatus according to claim 1, wherein the supporting body is constituted of a polyhedron including the plurality of first plates.

3. The workpiece connecting apparatus according to claim 2, wherein the distal end of the first articulated robot is connected to one of the first plates constituting the polyhedron.

4. The workpiece connecting apparatus according to claim 2, wherein the polyhedron includes an opening surface and a cavity therein, and each of the plurality of first plates is clamped to the polyhedron by a fastener from the cavity and is separately connected to one of faces constituting the polyhedron.

5. The workpiece connecting apparatus according to claim 3, wherein the polyhedron includes an opening surface and a cavity therein, and each of the plurality of first plates is clamped to the polyhedron by a fastener from the cavity and is separately connected to one of faces constituting the polyhedron.

6. The workpiece connecting apparatus according to claim 1, wherein a disk smaller than an area of the first plate and having a predetermined thickness is fixed to an outer surface of the first plate.

7. The workpiece connecting apparatus according to claim 2, wherein a disk smaller than an area of the first plate and having a predetermined thickness is fixed to an outer surface of the first plate.

8. The workpiece connecting apparatus according to claim 3, wherein a disk smaller than an area of the first plate and having a predetermined thickness is fixed to an outer surface of the first plate.

9. The workpiece connecting apparatus according to claim 4, wherein a disk smaller than an area of the first plate and having a predetermined thickness is fixed to an outer surface of the first plate.

10. The workpiece connecting apparatus according to claim 5, wherein a disk smaller than an area of the first plate and having a predetermined thickness is fixed to an outer surface of the first plate.

11. The workpiece connecting apparatus according to claim 1, wherein the first plate has a structure whose central portion protrudes.

12. The workpiece connecting apparatus according to claim 2, wherein the first plate has a structure whose central portion protrudes.

13. The workpiece connecting apparatus according to claim 3, wherein the first plate has a structure whose central portion protrudes.

14. The workpiece connecting apparatus according to claim 6, wherein the first plate has a structure whose central portion protrudes.

15. The workpiece connecting apparatus according to claim 7, wherein the first plate has a structure whose central portion protrudes.

16. The workpiece connecting apparatus according to claim 8, wherein the first plate has a structure whose central portion protrudes.

17. The workpiece connecting apparatus according to claim 1, the workpiece connecting apparatus comprising a second articulated robot disposed to face the first articulated robot, and including an ultrasonic transducer for connecting the second workpiece to the front surface of the first workpiece.

18. A workpiece connecting apparatus that urges a second workpiece against a front surface of a first workpiece to connect the second workpiece to the front surface of the first workpiece, the workpiece connecting apparatus comprising:
a second plate configured to move from a back surface side of the first workpiece toward the first workpiece, and be inclined in accordance with a back surface shape of the first workpiece to abut on the back surface of the first workpiece,
wherein the second plate is capable of being fixed in an inclined state in accordance with the back surface shape of the first workpiece.

19. The workpiece connecting apparatus according to claim 18, wherein the second plate has a structure whose central portion protrudes.

20. The workpiece connecting apparatus according to claim 18, the workpiece connecting apparatus comprising a second articulated robot disposed to face the first articulated robot, and including an ultrasonic transducer for connecting the second workpiece to the front surface of the first workpiece.
